(19) United States
(12) Patent Application Publication
(10) Pub. No.: US 2023/0320392 A1
(43) Pub. Date: Oct. 12, 2023

(54) ISOLATED PLANT PROTEIN COMPOSITIONS WITH LOWERED VOLATILE ORGANIC COMPOUNDS

(71) Applicant: Eat JUST, Inc., Alameda, CA (US)

(72) Inventors: Vivek SHARMA, Fremont, CA (US); Paul Joseph CASEY, San Francisco, CA (US); Jing JIANG, San Francisco, CA (US); Sayani MALLICK, San Francisco, CA (US); Saurabh WAIKAR, San Francisco, CA (US); Michael JAMROS, Oakland, CA (US)

(21) Appl. No.: 18/131,121

(22) Filed: Apr. 5, 2023

Related U.S. Application Data
(60) Provisional application No. 63/328,167, filed on Apr. 6, 2022.

(51) Int. Cl. A23L 11/00; A23J 1/14

(52) U.S. Cl. CPC A23L 11/01; A23J 1/144

(57) ABSTRACT

Plant protein isolates obtained from wet-milled pulse, wet-milled pulse flour and methods of producing wet-milled pulse flour are provided. Volatile organic compounds that are present in plant protein isolates prepared from the wet-milled pulse are decreased as compared the plant protein isolates prepared from a dry-milled pulse. Food compositions containing the plant protein isolates are disclosed.

### CROSS-REFERENCE TO RELATED APPLICATION

This application claims the benefit of U.S. Provisional Patent Application No. 63/328,167, filed Apr. 6, 2022. The entire content of the above-referenced application is hereby incorporated by reference.

### FIELD OF THE INVENTION

The present disclosure relates to wet milling legumes. The volatile small molecule compounds present in the wet-milled legumes are lower than the small molecule compounds present in a dry-milled legume. Proteins isolated from the wet-milled legume comprise lower amounts of small molecule compounds than the small molecule compounds present in proteins isolated from dry milled legumes. The isolated proteins from the wet-milled legumes can be used as foods or as ingredients in food products.

### BACKGROUND

Use of plant-based proteins such as soy and pea as animal protein substitutes have garnered increasing attention as consumers seek alternatives to conventional animal-based products to reduce the environmental impacts of animal husbandry and to improve dietary options that minimize the negative implications of consuming many animal protein products.

Conventional methods and processes used for extracting plant protein isolates and concentrates include alkaline extraction, acid precipitation, and filtration methods, including ultrafiltration. The quality of the plant protein compositions produced by these methods is directly dependent on the operating conditions used to prepare them. Typically, plant proteins are isolated from flours prepared from plant material such as pulses. The flours are prepared typically by milling dried pulses, also known as dry milling. Application of an acidic, alkaline, pH neutral extraction process or filtration methods influences the taste, odor and functional properties, e.g., the gelling, foaming or emulsifying properties of the protein compositions obtained, which can make the resulting protein compositions unsuitable for certain applications. There remains a need for processes of isolating plant-based proteins with physical characteristics and organoleptic properties desirable for the production of food products, including alternatives to conventional products containing animal proteins.

### SUMMARY

In one aspect, the present disclosure provides isolated plant protein compositions obtained from wet-milled pulses.

In one aspect, the present disclosure provides an isolated wet-milled pulse plant protein composition, the isolated plant protein composition comprising volatile small molecule compounds, wherein the amount of volatile small molecule compounds present in the isolated plant protein composition is decreased as compared to the amount of volatile small molecule compounds present in an isolated dry-milled plant protein composition. The change in the amount of the volatile small molecule compounds alters the odor or flavor of the isolated plant protein compositions obtained from the wet-milled pulse, the wet-milled pulse, or the starches and fibers isolated from the wet-milled pulse.

In one aspect, the present disclosure provides a method of manufacturing an isolated plant protein composition of, the method comprising the steps of incubating a pulse in an aqueous solvent to prepare a hydrated pulse. In one aspect, the method comprises milling the hydrated pulse to prepare wet-milled pulse. In one aspect, the method comprises isolating the plant protein composition from the wet-milled pulse, the isolated plant protein composition comprising volatile small molecule compounds, wherein the amount of volatile small molecule compounds present in the isolated dry-milled plant protein composition is decreased as compared to the amount of volatile small molecule compounds present in an isolated dry-milled plant protein composition isolated from a dry-milled pulse.

In one aspect, the present disclosure provides a method of preparing a wet-milled pulse, the method comprising the steps of incubating a pulse in an aqueous solvent to prepare a hydrated pulse. In one aspect, the method comprises milling the hydrated pulse to prepare the wet-milled pulse. In one aspect, the method comprises removing the aqueous solvent from the wet-milled pulse to prepare the wet-milled pulse, the wet-milled pulse comprising volatile small molecule compounds, wherein the amount of volatile small molecule compounds present in the wet-milled pulse is decreased as compared to the amount of volatile small molecule compounds present in a dry-milled pulse.

In one aspect, the present disclosure provides a method for preparing isolated plant protein compositions from a wet-milled pulse. From the wet-milled pulse a protein enriched fraction containing extracted pulse proteins can prepared by ultrafiltration, precipitation at a desired pH or other well-known method of isolating protein. When using ultrafiltration, the wet-milled pulse is subjected to an ultrafiltration process which uses a semi-permeable membrane to separate a retentate fraction from a permeate fraction based on molecular size at a temperature of from 2° C. to 60° C.; and collecting the retentate fraction containing the plant protein isolate. In another aspect, proteins can be extracted from the wet-milled pulse by precipitating the protein at a desired pH. The optimal pH for precipitating the plant protein can be determined by the operator. Sometimes, the pH for precipitating the proteins is the pKᵢ of the protein or can be a pH that is different from the pKᵢ. Precipitation of proteins by pH adjustment is known as isoelectric precipitation (IEP). IEP can be performed by the methods taught in the applicant's patent application WO2017/143298, herein incorporated by reference. In one embodiment, the proteins are isolated from pulse flour by the methods taught in the applicant's patent applications 62/981,890; 63/018,692; PCT/US2021/019931 (filed on Feb. 26, 2021), and WO 2021174017 (published on Sep. 2, 2021), herein incorporated by reference.

In an aspect, the present disclosure provides methods of preparing isolated plant protein compositions from non-heat-treated pulses by wet milling a non-heat-treated pulse. In one aspect, a dehulled pulse or a pulse that is not dehulled (unhulled) is wet-milled in an aqueous solvent at one or more desired temperatures to produce the wet-milled pulse. In one embodiment, heat treatment of the pulse is performed with exposure to steam or without exposure to steam.

In another aspect, methods of preparing wet-milled pulses are provided. In one embodiment, wet-milled pulse is prepared by milling the pulse in an aqueous solvent. In another embodiment, the pulse is incubated in an aqueous solution at a pH of from about 1 to about 10 at a desired temperature and for a desired amount of time to produce a hydrated pulse. The hydrated pulse is wet-milled to produce a wet-milled pulse.

In an aspect, the particle size of the wet-milled pulse is between 0.5 μm and 10000 μm. In one aspect, the particle size distribution of the wet-milled pulse is between 0.5 μm and 8 μm, between 10 μm and 100 μm, or between 400 μm and 1500 μm. In another aspect, the particle sizes of the wet-milled pulse is characterized by having a trimodal particle size distribution. The trimodal particle size distribution of the wet milled pulse comprises particles having a particle size distribution of between 0.5 μm and 8 μm, 10 μm and 100 μm and/or between 400 μm and 1500 μm. The trimodal particle size distribution of the dry milled pulse comprises particles having an average particle size of 1 μm±0.4 μm, 20 μm±5 μm, and 650 μm±135 μm. The trimodal particle size distribution of the wet milled pulse comprises particles having an average particle size of 1 μm±0.4 μm, 20 μm±5 μm, and 650 μm±135 μm.

In one aspect, the wet-milled pulse comprises volatile small molecule compounds, wherein the amount of the volatile small molecule compounds present in the wet-milled pulse is decreased as compared to the amount of volatile small molecule compounds present in a dry milled pulse.

In one aspect, methods of preparing wet-milled pulses are provided. In another embodiment, the wet-milled pulse comprises incubating the pulse in an aqueous solution at a pH of from about 1 to about 10 at a desired temperature and for a desired amount of time to produce a hydrated pulse. The hydrated pulse is wet-milled to produce a wet-milled pulse.

In one embodiment, a wet-milled pulse that has been air-dried first is air classified to separate denser flour particles from the less dense particles to prepare air-classified flour, prior to the aqueous extraction step for producing the protein rich fraction containing extracted pulse proteins.

In any embodiments disclosed herein, the wet-milled pulse may comprise wet-milled pulses prepare from beans, lentils, faba beans, dry peas, chickpeas, cowpeas, bambara beans, pigeon peas, lupins, vetches, adzuki, common beans, fenugreek, long beans, lima beans, runner beans, tepary beans, soy beans, or mucuna beans. In any embodiments of the methods, the milled composition may comprise Vigna angularis, Vicia faba, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the wet-milled composition comprises mung beans (Vigna radiata). In other embodiments, the wet-milled composition may comprise compositions prepared from nuts such as almonds and other nuts, seeds such as sesame seeds, sunflower seeds, and other commonly consumed nuts, fruits and seeds.

In any embodiments provided herein, the retentate fraction of the UF prepared protein comprises pulse proteins having a molecular size of less than 100 kilodaltons (kDa). In some cases, the retentate fraction comprises pulse proteins having a molecular size of less than 50 kDa. In some cases, the retentate fraction comprises pulse proteins having a molecular size of less than 25 kDa. In some cases, the retentate fraction comprises pulse proteins having a molecular size of less than 15 kDa.

In any embodiments of the methods, the semi-permeable membrane for UF protein production may be a polymeric membrane, a ceramic membrane, or a metallic membrane. In various embodiments, the permeable membrane is made from polyvinylidine fluoride (PVDF), polyether sulfone (PES), polyacrylonitrile (PAN), polytetrafluoroethylene (PTFE), polyamide-imide (PAI), a natural polymer, rubber, wool, cellulose, stainless steel, tungsten, palladium, an oxide, a nitride, a metallic carbide, aluminum carbide, titanium carbide, or a hydrated aluminosilicate mineral containing an alkali and alkaline-earth metal.

In any embodiment of the methods, the ultrafiltration process is performed at a pressure of from about 20 to about 500 psig.

In another aspect, the present disclosure provides isolated plant protein compositions prepared by any one of the methods discussed above or herein.

In another aspect, the present disclosure provides a food composition comprising a pulse protein isolate discussed above or herein, and one or more edible ingredients.

In any of the various embodiments of the isolated pulse protein, the pulse protein may have been isolated from dry beans, lentils, faba beans, dry peas, chickpeas, cowpeas, bambara beans, pigeon peas, lupins, vetches, adzuki, common beans, fenugreek, long beans, lima beans, runner beans, tepary beans, soy beans, or mucuna beans. In any of the various embodiments of the isolated pulse protein, the pulse protein may be isolated from Vigna angularis, Vicia faba, Cicer arietinum, Lens cuhnaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the isolated pulse protein is isolated from mung beans (Vigna radiata). In other embodiments, the milled composition may comprise almonds and other nuts, seeds such as sesame seeds, sunflower seeds, and other commonly consumed nuts, fruits and seeds.

In any of the various embodiments of the isolated pulse protein, the pulse protein may include proteins having a molecular size of less than 100 kDa. In some embodiments, the pulse protein includes proteins having a molecular size of less than 50 kDa. In some embodiments, the pulse protein includes proteins having a molecular size of less than 25 kDa. In some embodiments, the pulse protein includes proteins having a molecular size of less than 15 kDa. In some embodiments, the pulse protein includes proteins having a molecular size of from 1 kDa to 99 kDa.

In various embodiments, any of the features or components of embodiments discussed above or herein may be combined, and such combinations are encompassed within the scope of the present disclosure. Any specific value discussed above or herein may be combined with another related value discussed above or herein to recite a range with the values representing the upper and lower ends of the range, and such ranges and all intermediate values are encompassed within the scope of the present disclosure.

In one embodiment, the volatile small molecule compound present in the isolated plant protein compositions obtained from the wet-milled pulse is selected from the group consisting of hexanal; 2-hexenal; 1-hexanol; 2-heptanone; 2-heptanal; 2-pentyl furan; nonanal; pentanal; octanal; dimethyl disulfide; and combinations thereof.

In an embodiment, the amount of volatile small molecule compounds present in the isolated plant protein compositions obtained from wet-milled pulse is decreased as compared to the amount of small molecule compounds present in an isolated plant protein compositions obtained from a dry-milled pulse.

In an embodiment, the amount of volatile small molecule compounds present in the wet-milled pulse is decreased as compared to the amount of small molecule compounds present in a dry milled pulse.

In one embodiment, the amount of hexanal; 2-hexenal; 1-hexanol; 2-heptanone; 2-heptanal; 2-pentyl furan; nonanal; pentanal; octanal; dimethyl disulfide; or combinations thereof present in the isolated plant protein compositions obtained from a wet-milled pulse is decreased as compared to the amount of small molecule compounds present in isolated plant protein compositions obtained from dry-milled pulse.

In one embodiment, the amount of hexanal; 2-hexenal; 1-hexanol; 2-heptanone; 2-heptanal; 2-pentyl furan; nonanal; pentanal; octanal; dimethyl disulfide; or combinations thereof present in wet-milled pulse is decreased as compared to the amount of small molecule compounds present in a dry-milled pulse.

In various embodiments, the amount of volatile small molecule compounds are determined by analyzing the volatile small molecule compounds obtained by headspace gas analysis, in-tube extraction dynamic headspace (ITEX-DHS), stirbar sorptive extraction (SBSE), solid phase microextraction (SPME) or purge and trap.

In an embodiment, headspace gas analysis is performed by analyzing the gas phase or vapor portion of a sample in a sealed chromatography vial. A sample to be analyzed is sealed in a chromatography vial, then the vial is heated for a period of time, with or without agitation, allowing the volatile small molecule compounds in the sample to volatilize into the headspace of the chromatography vial. A sample of the headspace gas is then removed by a syringe and analyzed, typically by injection into a GC or GC/MS instrument.

In an embodiment, the volatile small molecule compounds can also be extracted by the purge and trap technique. In the purge and trap technique, a measured amount of a sample is placed in a sealed vessel, then the sample is purged with an inert gas, causing the analyte volatile small molecule compounds to be swept out of the sample. The analytes are then passed over an adsorbent or absorbent surface, which serves as trap where volatile small molecules are retained. The analytes are then desorbed by heating the trap and injected into a GC. GC/MS or other analytical instrument, by backflushing the trap with the carrier gas into, for example, the GC/MS.

In an embodiment, the volatile small molecule compounds can be extracted by ITEX-DHS. Analyte extraction by ITEX-DHS involves repeatedly pumping a syringe inserted into the headspace area of a vial, typically after the sample undergoes an incubation period with heating and agitation, to enrich an adsorbent or absorbent surface within the syringe to which volatile analyte compounds reversibly bind. Next, the adsorbent or absorbent (from the syringe) is heated, which results in desorption of the volatile organic compounds from the adsorbant or absorbant. The desorbed analytes are analyzed by analytical techniques, for example by GC/MS or other chromatographic and/or mass spectroscopic analysis.

In an embodiment, the volatile small molecule compounds can be extracted by stir bar sorptive extraction (SBSE). SBSE is a sample extraction and enrichment technique whereby a magnetic stir bar coated with a sorptive material is introduced into a sample and is used to mix the sample of interest. While the sorptive coated stir bar is in contact with the sample, the analyte volatile compounds bind the stir bar. After a desired incubation time, the analytes adsorbed (or absorbed) onto the stir bar are desorbed from the sorptive material by exposure to heat, solvents or other well understood methods. The desorbed analyte volatile molecule compounds are the analyzed by analytical techniques, for example by GC/MS or other chromatographic and/or mass spectroscopic analysis.

In an embodiment, the volatile small molecule compounds can be extracted by solid phase microextraction (SPME), a solventless sample extraction technique. In SPME, analytes first establish an equilibrium amongst the sample, the headspace of a vial containing the sample, and a polymer-coated fused fiber. The analytes are obtained through the absorption or adsorption (dependent on the fiber) of analyte compounds from the sample onto the fiber, which then transfers analytes into the headspace. Analyte compounds are then introduced to the GC/MS or other analytical instruments, either through via an injection taken from the headspace or the fiber may be inserted directly into the GC/MS for desorption and analysis.

In certain embodiments, the isolated plant protein compositions obtained from wet-milled pulse, wherein the pulse dehulled (hull removed) or undehulled.

In one embodiment, the method comprises incubating undehulled (without removal of the hull) pulse in a solvent at a desired temperature for a desired amount of time to remove the hulls. In this embodiment, the incubation of the pulse in the solvent removes the hull from the pulse.

In one embodiment, the heat treatment of pulses comprises exposing the pulse, either dehulled or undehulled, in the absence of solvent, to one or more heating zones for a desired amount of time. The temperature of one heating zone may be different than the temperature of another heating zone. Optionally, after treatment in the one or more heating zones, the pulses are exposed to a cooling zone to cool the heat treated pulse to a desired temperature. The heat treated pulse is wet-milled to prepare wet-milled heat treated pulse.

In an embodiment of heat treating the pulse, the pulse is exposed to steam in the one or more heating zones. The temperature of the steam is at a desired temperature of between 100° C. to 500° C.

In an embodiment, the temperature of the one or more heating zones is at a desired temperature. The desired temperature of the one or more heating zones in one embodiment is between 50° C. to 300° C.

In one embodiment, the temperature of a first heating zone is lower or higher than the temperature of a second heating zone. In an embodiment, the temperature of a first heating zone is between 110° C. to 150° C. In an embodiment, the temperature of a second heating zone is between 180° C. to 225° C.

In an embodiment, the temperature of the cooling zone is between 10° C. to 100° C.

In an embodiment, the amount of time that the pulse is exposed to heat (residence time) is determined by the skilled worker. In one embodiment, the residence time of the pulse in the one or more heating zones is between 1 and 60 minutes. In one embodiment, the residence time of the pulse in the one or more heating zones can be the same or different. In one embodiment, the residence time of the pulse in the first heating zone is shorter or longer than the residence time of the pulse in the second heating zone. In yet another embodiment, the residence time of the pulse in the cooling zone can be determined by the skilled worker. In an embodiment, the residence time of the pulse in the cooling zone is between 1 minute and 60 minutes.

### BRIEF DESCRIPTION OF THE DRAWINGS

FIG. 1 shows the decreases in the amounts of the identified VOCs in isolated plant protein obtained from a wet-milled pulse and isolated plant protein compositions obtained from a dry-milled pulse.

FIGS. 2A-2B show a trimodal particle size distribution of wet-milled and dry-milled pulses.

### DETAILED DESCRIPTION

Before the present invention is described, it is to be understood that this invention is not limited to particular methods and experimental conditions described, as such methods and conditions may vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. As used herein, the term “about,” when used in reference to a particular recited numerical value, means that the value may vary from the recited value by no more than 1%. For example, as used herein, the expression “about 100” includes 99 and 101 and all values in between (e.g., 99.1, 99.2, 99.3, 99.4, etc.).

Although any methods and materials similar or equivalent to those described herein can be used in the practice or testing of the present invention, the preferred methods and materials are now described. All patents, applications and non-patent publications mentioned in this specification are incorporated herein by reference in their entireties.

### Definitions

As used herein, the singular forms “a,” “an,” and “the” include the plural referents unless the context clearly indicates otherwise.

The term “reduce”, “reduced”, “depleted”, “decreased” or similar terms indicates a lessening or decrease of an indicated value relative to a reference value. In some embodiments, the term “reduce” (including “reduction”) refers to a lessening or a decrease of an indicated value to a reference value. When used in reference to volatile small molecule compound, “reduced” means that the amounts or concentrations of one or more small molecule compounds present in the isolated plant protein compositions obtained from a wet-milled pulse, or the wet-milled pulse flour is decreased, reduced or lowered as compared to isolated plant protein compositions obtained from a dry milled pulse, or a dry milled pulse, respectively.

The term “increase”, “increased”, “enriched” or similar terms indicates an increase or increasing of an indicated value relative to a reference value. In some embodiments, the term “increase” (including “increasing”) refers to an increase of an indicated value. When used in reference to volatile small molecule compound, “increased” means that the amounts or concentrations of one or more small molecule compounds present in the isolated plant protein compositions obtained from a wet-milled pulse, or the wet-milled pulse flour is decreased, reduced or lowered as compared to isolated plant protein compositions obtained from a dry milled pulse, or a dry milled pulse flour, respectively.

As used herein, the term “egg(s)” includes but is not limited to chicken eggs, other bird eggs (such as quail eggs, duck eggs, ostrich eggs, turkey eggs, bantam eggs, goose eggs), and fish eggs such as fish roe. Typical food application comparison is made with respect to chicken eggs.

As used herein, “molecular weight,” “molecular size” or similar expressions refer to the molecular mass of compounds, such as proteins, expressed as dalton (Da) or kilodalton (kDa). The molecular weight of a compound can be precise or can be an average molecular mass. For example, the molecular weight of a discrete compound, such as NaCl or a specific protein can be precise. For the molecular sizes of protein isolates of the invention, an average molecular mass is typically used. For example, protein isolates obtained in the retentate fraction of a purification process using an ultrafiltration membrane having a molecular weight cut-off of 10 kDa are depleted in proteins (and other compounds) that have an average molecular weight of less 10 kDa. The retentate fraction from a 10 kDa UF membrane can also be described as being enriched in proteins (and other compounds) that have an average molecular weight of greater than 10 kDa. The permeate fraction of a purification process using an ultrafiltration membrane having a molecular weight cut-off of 10 kDa is enriched in proteins (and other compounds) that have an average molecular weight of less than 10 kDa. The permeate fraction from a 10 kDa UF membrane can also be described as being depleted in proteins (and other compounds) that have an average molecular weight of greater than 10 kDa.

As used herein, “plant source of the isolate” refers to a whole plant material such as whole mung bean or other pulse, or from an intermediate material made from the plant, for example, a dehulled bean, a undehulled bean, a flour, a powder, a meal, ground grains, a cake (such as, for example, a defatted or de-oiled cake), or any other intermediate material suitable to the processing techniques disclosed herein to produce a purified protein isolate.

The term “dehulled” or “hulled” when used to describe a pulse means a pulse in which the hull of the pulse has been removed.

The term “unhulled” when used to describe a pulse means a pulse in which the hull of the pulse has not been removed.

The term “transglutaminase” refers to an enzyme (R-glutamyl-peptide:amine glutamyl transferase) that catalyzes the acyl-transfer between γ-carboxyamide groups and various primary amines, classified as EC 2.3.2.13. It is used in the food industry to improve texture of some food products such as dairy, meat and cereal products. It can be isolated from a bacterial source, a fungus, a mold, a fish, a mammal and a plant.

The terms “majority” or “predominantly” with respect to a specified component, e.g., small molecule compound, refer to the component having at least 50% by weight of the referenced batch, process stream, food formulation or composition.

Unless indicated otherwise, percentage (%) of ingredients refer to total % by weight typically on a dry weight basis unless otherwise indicated.

The term “isolated plant protein”, “purified protein isolate”, “protein isolate”, “isolate”, “protein extract”, “isolated protein” or “isolated polypeptide” refers to a protein fraction, a protein or polypeptide that by virtue of its origin or source of derivation (1) is not associated with naturally associated components that accompany it in its native state, (2) exists in a purity not found in nature, where purity can be adjudged with respect to the presence of other cellular material (e.g., is free of other proteins from the same species) (3) is expressed by a cell from a different species, or (4) does not occur in nature (e.g., it is a fragment of a polypeptide found in nature or it includes amino acid analogs or derivatives not found in nature or linkages other than standard peptide bonds). One or more proteins or fractions may be partially removed or separated from residual source materials and/or non-solid protein materials and, therefore, are non-naturally occurring and are not normally found in nature. A polypeptide or protein may also be rendered substantially free of naturally associated components by isolation, using protein purification techniques known in the art and as described herein. A polypeptide that is chemically synthesized or synthesized in a cellular system different from the cell from which it naturally originates will be “isolated” from its naturally associated components. As thus defined, “isolated” does not necessarily require that the protein, polypeptide, peptide or oligopeptide so described has been physically removed from its native environment.

The term “heat treated pulse,” “heat treated pulse flour” or “heat treated flour” refers to pulses or milled pulses that have been exposed to heat. The milling can occur before or after heat treatment. The term also refers to pulses or milled pulses that have been exposed to steam before, during or after exposure of the pulses to heat.

The term “mill,” “milling,” “milled” and the like refers to the process of or the product produced by reducing the size of a pulse by grinding, crushing, macerating or other methods.

The term “wet-milled pulse” refers to pulse particles prepared by milling the pulse in an aqueous solvent. The term “wet-milled pulse” is used interchangeably with “wet-milled pulse flour.”

The term “dry-milled pulse” refers to a flour prepared by milling a pulse in the absence of a solvent. The term “dry-milled pulse” is used interchangeably with “dry-milled pulse flour.”

The term “aqueous solvent” refers to a water based fluid. The aqueous solvent can comprise salts. The aqueous solvent can comprise fluids that are miscible in water, such as alcohols, including ethanol.

The term “hydrated pulse” refers to pulses that have been incubated in an aqueous solvent.

The term “incubate,” “incubating,” “incubated,” “steep,” “steeping,” “steeped,” and the like refer to exposing a pulse or other plant material in a solvent.

The terms “volatile small molecule compound” or “small molecule compound” refers to compounds present in the pulse before, during or milling of the pulse.

The term “heating zone,” “heating portion,” “heating section,” and the like refers to one or more zones of a dryer in which the temperature of a heating zone can be independently controlled from the temperature of other heating zones.

The term “cooling zone,” “cooling portion,” “cooling section,” and the like refers to one or more zones of a dryer in which the temperature of a cooling zone can be independently controlled from the temperature of other cooling zones.

As used herein the term “residence time” refers to the amount of time that a pulse resides in the one or more heating zones or the one or more cooling zones.

As used herein “volatile small molecule compound(s)” or “small molecule compound” refers to compound having a molar mass or molecular weight of less than 2,000 Da, less than 1500 Da, less that 1,000 Da, less than 750 Da or less than 500 Da.

As used herein “pulse” refers to legumes that are grown and harvested as food.

Isolated Plant Protein Compositions Obtained from Wet-Milled Pulse

In one embodiment, provided are isolated plant protein compositions obtained from wet-milled pulses.

The plant protein isolates are obtained from wet-milled pulses wherein the volatile small molecule compounds present in the plant protein isolate is decreased, or unaltered as compared to the amount of small molecule compounds present in a protein isolate obtained dry-milled pulses. The presence and concentrations of the one or more volatile small molecule compounds alters the flavor and/or odor of the protein isolate. The flavor and/or odor of a food product, for example an egg substitute, that comprises protein isolates obtained from wet-milled pulse flour is thereby improved.

In an embodiment, the amount or concentration of one or more volatile small molecule compounds present in the isolated plant protein compositions obtained from wet-milled pulse is decreased as compared to the small molecule compounds present in isolated plant protein compositions obtained from dry milled pulse.

In an embodiment, the amount or concentration of one or more volatile small molecule compounds present in isolated plant protein compositions obtained from wet-milled pulses is unaltered or remains the same as compared to the small molecule compounds present in isolated plant protein compositions obtained from dry milled pulses.

The presence and concentrations of the one or more volatile small molecule compounds alters the flavor and/or odor of the isolated plant protein compositions obtained from wet-milled pulse. The flavor and/or odor of a food product, for example an egg substitute, that comprises isolated plant protein compositions obtained from wet-milled pulse is thereby improved.

In an embodiment the amount of the one or more volatile small molecule compounds in isolated plant protein compositions obtained from wet-milled pulse is decreased by 1-10000 fold (1×-10,000×), between 1×-5,000×, between 1×-4,000×, between 1×-3,000×, between 1×-2,000×, between 1×-1,000×, between 1×-500×, between 1×-400×, between 1×-300×, between 1×-200×, between 1×-100×, between 1×-75×, between 1×-50×, between 1×-30×, between 1×-20×, between 1×-10×, between 1×-5×, between 1×-3×, or between 1×-2× as compared to isolated plant protein compositions obtained from dry-milled pulse.

In an embodiment the amount of the one or more volatile small molecule compounds in the isolated plant protein compositions obtained from wet-milled pulse is decreased by between: 1% and 5%, 5% and 10%, 10% and 15%, 15% and 20%, 20% and 25%, 25% and 30%, 30% and 35%, 35% and 40%, 40% and 45%, 45% and 50%, 50% and 55%, 55% and 60%, 60% and 65%, 65% and 70%, 70% and 75%, 75% and 80%, 80% and 85%, 85% and 90%, 90% and 95%, 95% and 99%, 5% and 25%, 25% and 50%, 50% and 75%, or 75% and 95%.

In an embodiment, various flavor and/or odor properties of the volatile small molecules have been identified. The disclosures provided herein provide the flavor and/or odor properties of the volatile small molecules.

In one embodiment, the isolated plant protein compositions obtained from a wet-milled pulse is obtained from a pulse selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soybeans, and mucuna beans. In an embodiment, the protein isolate is obtained from the genus Vigna. In another embodiment, the protein isolate is obtained from the species Vigna radiata or Vigna radiata.

In an embodiment, the presence and/or concentrations of the volatile small molecule compounds are isolated and detected by methods known to the skilled artisan. Isolation of the volatile small molecule compounds can be achieved by headspace gas analysis, in-tube extraction dynamic headspace (ITEX-DHS), stirbar sorptive extraction (SB SE), or solid phase microextraction (SPME). Once the compounds are obtained, they are analyzed by gas chromatography (GC), liquid chromatography (LC), high performance liquid chromatography (HPLC), mass spectroscopy (MS), nuclear magnetic resonance (NMR), infrared spectroscopy (IR), optical spectroscopy, and other techniques such as GC/MS.

Wet-Milled Pulses

The present disclosure provides wet-milled pulses. The wet-milled pulse can also be referred to as wet-milled pulse flour.

Disclosed herein are wet-milled pulses wherein the volatile small molecule compounds present in the wet-milled pulse is decreased, or unaltered as compared to the amount of small molecule compounds present in dry milled pulses. The presence and concentrations of the one or more volatile small molecule compounds alters the flavor and/or odor of the wet-milled pulse plant proteins isolated from the wet-milled pulses. The changes in the amounts of the volatile small molecule compounds in the wet-milled pulse alters the flavor and/or odor of the proteins isolated from the wet-milled pulse. The flavor and/or odor of a food product, for example an egg substitute, that comprises isolated plant protein compositions obtained from wet-milled pulse is thereby improved.

Disclosed herein are wet-milled pulses wherein the volatile small molecule compounds present in wet-milled pulse is decreased, or unaltered as compared to the amount of small molecule compounds present in dry-milled pulse.

In an embodiment, the amount of at least one, two, three, four, five, six, seven, eight, nine ten, or more than ten volatile small molecule compound present in isolated protein obtained from wet-milled pulse is decreased as compared to dry-milled pulse.

In an embodiment, the amount of at least one, two, three, four, five, six, seven, eight, nine ten, or more than ten volatile small molecule compound present in the wet-milled pulse is decreased as compared to dry-milled pulse.

In an embodiment, the amount or concentration of one or more volatile small molecule compounds present in wet-milled pulse is decreased as compared to the small molecule compounds present in dry-milled pulse.

In an embodiment, the amount of the one or more volatile small molecule compounds in wet-milled pulse is decreased by 1-10000 fold (1×-10,000×), between 1×-5,000×, between 1×-4,000×, between 1×-3,000×, between 1×-2,000×, between 1×-1,000×, between 1×-500×, between 1×-400×, between 1×-300×, between 1×-200×, between 1×-100×, between 1×-75×, between 1×-50×, between 1×-30×, between 1×-20×, between 1×-10×, between 1×-5×, between 1×-3×, or between 1×-2× as compared to proteins isolated from dry-milled pulse, respectively.

In an embodiment, the amount of the one or more volatile small molecule compounds in proteins isolated from wet-milled pulse is decreased by 1-10000 fold (1×-10,000×), between 1×-5,000×, between 1×-4,000×, between 1×-3,000×, between 1×-2,000×, between 1×-1,000×, between 1×-500×, between 1×-400×, between 1×-300×, between 1×-200×, between 1×-100×, between 1×-75×, between 1×-50×, between 1×-30×, between 1×-20×, between 1×-10×, between 1×-5×, between 1×-3×, or between 1×-2× as compared to proteins isolated from dry-milled pulse, respectively.

In an embodiment the amount of the one or more volatile small molecule compounds in the proteins compositions isolated from wet-milled pulse is decreased by between: 1% and 5%, 5% and 10%, 10% and 15%, 15% and 20%, 20% and 25%, 25% and 30%, 30% and 35%, 35% and 40%, 40% and 45%, 45% and 50%, 50% and 55%, 55% and 60%, 60% and 65%, 65% and 70%, 70% and 75%, 75% and 80%, 80% and 85%, 85% and 90%, 90% and 95%, 95% and 99%, 5% and 25%, 25% and 50%, 50% and 75%, or 75% and 95%.

In an embodiment the amount of the one or more volatile small molecule compounds in wet-milled pulse is decreased by between: 1% and 5%, 5% and 10%, 10% and 15%, 15% and 20%, 20% and 25%, 25% and 30%, 30% and 35%, 35% and 40%, 40% and 45%, 45% and 50%, 50% and 55%, 55% and 60%, 60% and 65%, 65% and 70%, 70% and 75%, 75% and 80%, 80% and 85%, 85% and 90%, 90% and 95%, 95% and 99%, 5% and 25%, 25% and 50%, 50% and 75%, or 75% and 95%.

In an embodiment, the amount of the one or more volatile small molecule compounds in wet-milled pulse is unaltered.

In an embodiment, flavor and/or odor properties of the volatile small molecules are as described herein.

In one embodiment, the particle size of the wet-milled pulse is between 0.5 μm and 10000 μm, between 5 μm and 5000 μm, between 10 μm and 5000 μm, between 10 μm and 4000 μm, between 10 μm and 3000 μm, between 10 μm and 2000 μm, between 10 μm and 1500 μm, between 10 μm and 1000 μm, between 10 μm and 900 μm, between 10 μm and 800 μm, between 10 μm and 700 μm, between 10 μm and 500 μm, between 10 μm and 400 μm, between 10 μm and 300 μm, between 10 μm and 200 μm, between 10 μm and 100 μm, between 100 μm and 5000 μm, between 100 μm and 4000 μm, between 100 μm and 3000 μm, between 100 μm and 2000 μm, between 100 μm and 1500 μm, or between 100 μm and 1000 μm.

In one embodiment, the particle size distribution of the wet-milled pulse or pulse flour is between 0.5 μm and 8 μm, between 10 μm and 100 μm, or between 400 μm and 1500 μm. In another embodiment, average particle size of the wet-milled pulse has a trimodal distribution. In one embodiment, the particle sizes of the wet-milled pulse particles comprise particles having a particle size distribution of between 0.5 μm and 8 μm, 10 μm and 100 μm and/or between 400 μm and 1500 μm. The trimodal particle size distribution of the dry-milled pulse comprises particles having an average particle size of 1 μm±0.2 μm, 20 μm±2 μm, and 650 μm±65 μm. The trimodal particle size distribution of the wet milled pulse comprises particles having an average particle size of 1 μm±0.2 μm, 20 μm±2 μm, and 650 μm±65 μm.

In one embodiment, the wet-milled pulse is prepared from a pulse selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soy beans, and mucuna beans. In an embodiment, the wet-milled pulse is of the genus Vigna. In another embodiment, the wet-milled pulse is of the species Vigna radiata or Vigna radiata.

In an embodiment, the pulse is not dehulled (unhulled), that is, a pulse in which the hull has not been removed from the pulse.

In an embodiment, the pulse is dehulled, that is, a pulse in which the hull has been removed from the pulse. The pulse is dehulled by contacting the pulse with a solvent for a desired amount of time. In one embodiment, the solvent used for dehulling the pulse is water, ethanol, oil, or other solvents. Optionally, salts such as sodium salts, potassium salts, ammonium salts or other salts can be added to the solvent. Without being bound by theory, it is believed that the incubation of the undehulled pulse removes the hull and also removes volatile small molecule compounds from the pulse.

In one embodiment, the temperature of the solvent for dehulling is maintained at a temperature of between: 20° C. to 100° C., 20° C. to 95° C., 20° C. to 90° C., 20° C. to 85° C., 20° C. to 80° C., 20° C. to 75° C., 20° C. to 70° C., 20° C. to 65° C., 20° C. to 60° C., 20° C. to 55° C., 20° C. to 50° C., 20° C. to 45° C., 20° C. to 40° C., 20° C. to 35° C., 20° C. to 30° C., 20° C. to 25° C., 25° C. to 100° C., 25° C. to 95° C., 25° C. to 90° C., 25° C. to 85° C., 25° C. to 25° C., 25° C. to 75° C., 25° C. to 70° C., 25° C. to 65° C., 25° C. to 60° C., 25° C. to 55° C., 25° C. to 50° C., 25° C. to 45° C., 25° C. to 40° C., 25° C. to 35° C., 25° C. to 30° C., 30° C. to 40° C., 40° C. to 50° C., 50° C. to 60° C., 60° C. to 70° C., 70° C. to 80° C., 80° C. to 90° C., or 90° C. to 100° C.

In one embodiment, the time that the pulse is contacted with the solvent to remove the hull is between: 30 minutes to 24 hours, 30 minutes to 24 hours, 30 minutes to 20 hours, 30 minutes to 15 hours, 30 minutes to 10 hours, 30 minutes to 9 hours, 30 minutes to 8 hours, 30 minutes to 7 hours, 30 minutes to 6 hours, 30 minutes to 5 hours, 30 minutes to 4 hours, 30 minutes to 3 hours, 30 minutes to 2 hours, 30 minutes to 1 hour, 1 hour to 20 hours, 1 hour to 15 hours, 1 hour to 10 hours, 1 hour to 9 hours, 1 hour to 8 hours, 1 hour to 7 hours, 1 hour to 6 hours, 1 hour to 5 hours, 1 hour to 4 hours, 1 hour to 3 hours, 1 hour to 2 hours, 2 hours to 24 hours, 2 hours to 24 hours, 2 hours to 20 hours, 2 hours to 15 hours, 2 hours to 10 hours, 2 hours to 9 hours, 2 hours to 8 hours, 2 hours to 7 hours, 2 hours to 6 hours, 2 hours to 5 hours, 2 hours to 4 hours, or 2 hours to 3 hours.

In an embodiment, the presence and/or concentrations of the volatile small molecule compounds are isolated and detected by methods known to the skilled artisan. Isolation of the volatile small molecule compounds can be achieved by headspace gas analysis, in-tube extraction dynamic headspace (ITEX-DHS), stirbar sorptive extraction (SB SE), or solid phase microextraction (SPME). Once the compounds are obtained they are analyzed by gas chromatography (GC), liquid chromatography (LC), high performance liquid chromatography (HPLC), mass spectroscopy (MS), nuclear magnetic resonance (NMR), infrared spectroscopy (IR), optical spectroscopy, and other techniques such as GC/MS.

Methods of Producing Wet-Milled Pulse

The present disclosure provides method of producing wet-milled pulses. The wet-milled pulse is prepared, in one embodiment, by incubating the pulse in an aqueous solvent to produce a hydrated pulse. The hydrated pulse is milled in an aqueous solvent to prepare the wet-milled pulse.

In one embodiment, the particle size of the wet-milled pulse is, between 0.5 μm and 10000 μm, between 5 μm and 5000 μm, between 10 μm and 5000 μm, between 10 μm and 4000 μm, between 10 μm and 3000 μm, between 10 μm and 2000 μm, between 10 μm and 1500 μm, between 10 μm and 1000 μm, between 10 μm and 900 μm, between 10 μm and 800 μm, between 10 μm and 700 μm, between 10 μm and 500 μm, between 10 μm and 400 μm, between 10 μm and 300 μm, between 10 μm and 200 μm, between 10 μm and 100 μm, between 100 μm and 5000 μm, between 100 μm and 4000 μm, between 100 μm and 3000 μm, between 100 μm and 2000 μm, between 100 μm and 1500 μm, or between 100 μm and 1000 μm.

In an embodiment, the particle size distribution of the wet-milled pulse is between 0.5 μm and 8 μm, between 10 μm and 100 μm, or between 400 μm and 1500 μm. In another embodiment, the particle sizes of the wet-milled pulse are characterized by having a trimodal particle size distribution. The trimodal particle size distribution of the wet milled pulse comprises particles having a particle size distribution of between 0.5 μm and 8 μm, 10 μm and 100 μm and/or between 400 μm and 1500 μm. The trimodal particle size distribution of the dry milled pulsed comprises particles having an average particle size of 1 μm±0.2 μm, 20 μm±2 μm and 650 μm±65 μm. The trimodal particle size distribution of the wet milled pulse comprises particles having an average particle size of 1 μm±0.2 μm, 20 μm±2 μm, and 650 μm±65 μm.

Particle size measurement methods are known to the skilled worker and many commercially available particle size analyzers are available for purchase. Commercially available instruments use many techniques, including dynamic light scattering, static light scattering, laser diffraction, air classification, sieving, microscope counting, and other known methods.

In an embodiment the wet-milled pulse prepared by the methods disclosed herein comprises volatile small molecule compounds, wherein the amount or concentrations of volatile small molecule compounds present in the wet-milled pulse is decreased, or is not altered as compared to the amount of small molecule compounds present in a dry-milled pulse. The identities and changes to the amount or concentrations of the volatile small molecules present in the wet-milled pulse are described elsewhere in this application.

In one embodiment of preparing wet-milled pulse, the aqueous solvent is an aqueous or water based fluid. The aqueous solvent comprises water and optionally, organic solvent that are miscible in water. Alcohols, including ethanol, are miscible in water.

In an embodiment, the aqueous solvent can be neat water or comprise sales. Exemplary salts include but are not limited to NaCl, NaHCO₃, Na₂CO₃, Na₂SO₄, NaH₂PO₄, Na₂HPO₄, Na₃PO₄. Na₂SO₄, KCl, KHCO₃, K₂CO₃, Na₂SO₄, KH₂PO₄, K₂HPO₄, K₃PO₄. K₂SO₄ sodium citrate, sodium acetate, potassium citrate, and potassium acetate.

In some cases, the salt concentration of the aqueous solvent is at least 0.01% w/v. In some cases, the salt concentration is at least 0.1% w/v. In some cases, the salt concentration is from 0.01% w/v to 5% w/v. In various embodiments, the salt concentration is 0.001%, 0.0025%, 0.005%, 0.0075%, 0.01%, 0.025%, 0.05%, 0.075%, 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, or 5.0%. In various embodiments, the salt is selected from sodium chloride, sodium sulfate, sodium phosphate, ammonium sulfate, ammonium phosphate, ammonium chloride, potassium chloride, potassium sulfate, or potassium phosphate. In some embodiments, the salt is NaCl. In some embodiments, the aqueous solution does not comprise a salt.

In yet another embodiment, the pH of the aqueous solvent can be a pH of between 1 to about 10, between 2 to about 10, between 2 to about 9, between 2 to about 8, between 3 to about 8, between 3 to about 7, between 4 to about 7, between 4 to about 6, between 4 to about 5, between 5 to about 10, between 5 to about 9, between 5 to about 8, between 5 to about 7, between 6 to about 10, between 6 to about 9, between 6 to about 8, or between 6 to about 7.

In one embodiment, the pulse is incubated (steeped) in an aqueous solvent to produce hydrated pulse. The pulse can be steeped in the aqueous solvent of a period of between 1 minute and 10 minutes, between 10 minutes and 20 minutes, between 20 minute and 30 minutes, between 30 minutes and 40 minutes, between 40 minutes and 50 minutes, between 50 minutes and 60 minutes, between 1 hour and 2 hours, between 2 hours and 3 hours; between 2 hours and 3 hours; between 3 hours and 4 hours; between 4 hours and 5 hours; between 5 hours and 6 hours; between 6 hours and 7 hours; between 7 hours and 8 hours; between 8 hours and 9 hours; between 10 hours and 11 hours; between 11 hours and 12 hours; between 12 hours and 13 hours; between 12 hours and 14 hours; between 14 hours and 15 hours; between 15 hours and 16 hours; between 16 hours and 17 hours; between 17 hours and 18 hours; between 18 hours and 19 hours; between 19 hours and 20 hours; between 21 hours and 22 hours; between 23 hours and 24 hours; between 24 hours and 25 hours; or between 1 day and 2 days.

In an embodiment, the temperature of the aqueous solvent is at a temperature of between 2° C. and 75°, between 3° C. and 75°, between 4° C. and 75°, between 4° C. and 70° C., between 4° C. and 65°, between 4° C. and 60° C., between 4° C. and 60°, between 4° C. and 55° C., between 4° C. and 50°, between 4° C. and 45° C., between 4° C. and 40°, between 4° C. and 35° C., between 4° C. and 30°, between 10° C. and 75° C., between 10° C. and 65°, between 10° C. and 60° C., between 10° C. and 55°, between 10° C. and 50° C., between 10° C. and 50°, between 10° C. and 45° C., between 10° C. and 40° C., between 10° C. and 35°, between 10° C. and 30° C., between 20° C. and 70°, between 20° C. and 60° C., between 20° C. and 50°, between 20° C. and 40° C., between 25° C. and 75° C., between 25° C. and 65°, between 25° C. and 60° C., between 25° C. and 55°, between 25° C. and 50° C., between 25° C. and 45°, or between 25° C. and 40° C.

In one embodiment, the aqueous solvent used for steeping the pulse is the same or different as the aqueous solvent used during milling the pulse. For example, the aqueous solvent for steeping could be at a temperature of 50° C. and a salt concentration of 0.1M. After the desired steeping time, the temperature, the salt concentration and/or the pH can be adjusted for milling.

In another embodiment, the hydrated pulse is milled for a desired amount of time. In one aspect, the pulse is milled for a period of between 5 seconds and 240 minutes, between 5 seconds and 180 minutes, between 5 seconds and 120 minutes, between 5 seconds and 90 minutes, between 5 seconds and 60 minutes, between 5 seconds and 50 minutes, between 5 seconds and 40 minutes, between 5 seconds and 30 minutes, between 5 seconds and 20 minutes, between 5 seconds and 10 minutes, between 30 seconds and 10 minutes, between 1 minutes and 10 minutes, between 5 minutes and 120 minutes, between 5 minutes and 90 minutes, between 5 minutes and 60 minutes, between 5 minutes and 50 minutes, between 5 minutes and 40 minutes, between 5 minutes and 30 minutes, between 5 minutes and 20 minutes, between 5 minutes and 15 minutes, between 10 minutes and 120 minutes, between 10 minutes and 90 minutes, between 10 minutes and 60 minutes, between 10 minutes and 50 minutes, between 10 minutes and 45 minutes, between 10 minutes and 40 minutes, between 10 minutes and 35 minutes, between 10 minutes and 30 minutes, between 10 minutes and 25 minutes, between 10 minutes and 20 minutes, between 10 minutes and 15 minutes, between 15 minutes and 60 minutes, between 15 minutes and 50 minutes, between 15 minutes and 45 minutes, between 15 minutes and 40 minutes, between 15 minutes and 35 minutes, between 15 minutes and 30 minutes, between 15 minutes and 25 minutes, or between 15 minutes and 20 minutes.

In an embodiment, during the milling process, the milled pulse can be recirculated into the mill for a desired number of times. During the milling process, the milled pulse can be passaged through the mill 2, 3, 4, 5, or more times.

In an embodiment, the methods provided herein produces wet-milled pulses in which the amount of at least one, two, three, four, five, six, seven, eight, nine ten, or more than ten volatile small molecule compound present in the wet-milled pulse is decreased as compared to a non-heat treated pulse.

The identities of the small molecules compounds are disclosed in other portions of this specification.

In an embodiment, the pulse is exposed to heat in the presence or absence of steam to prepare heat-treated pulse. In one embodiment, the pulse is exposed to dry heat, that is, the pulse is exposed to heat without the use of steam. In one embodiment, the pulse is exposed to heat with the use of steam. The exposure of the pulse to heat by use of steam is referred to as “steam stripping.” When the term “heat” is used herein, the term refers to dry heat, steam heat or both. The heat-treated pulse is wet-milled in an aqueous solvent to prepare wet-milled pulse.

In an embodiment, the heat treatment of the pulses is accomplished by exposing the pulses to one or more heating zones in a dryer. There can be one, two, three, four or more heating zones in the dryer. The temperatures of the one or more heating zones can be individually controlled. The temperature of one or a first heating zone may be different than the temperature of another or second zone. In one embodiment, the temperature of the first heating zone is lower than the temperature of another heating zone, for example, the second heating zone or a third heating zone. In one embodiment, the temperature of the first heating zone is higher than the temperature of another heating zone, for example, the second heating zone or a third heating zone. The skilled worker will understand that each heating zone can be controlled individually and that the temperature of each heating zone can be higher or lower than another heating zone.

In one embodiment, the temperature of the one or more heating zones is individually between: 75° C. to 500° C., 100° C. to 500° C., 100° C. to 475° C., 100° C. to 450° C., 100° C. to 425° C., 100° C. to 400° C., 100° C. to 375° C., 100° C. to 350° C., 100° C. to 325° C., 100° C. to 300° C., 100° C. to 275° C., 100° C. to 250° C., 100° C. to 225° C., 100° C. to 200° C., 100° C. to 175° C., 100° C. to 150° C., 100° C. to 125° C., 125° C. to 400° C., 125° C. to 375° C., 125° C. to 350° C., 125° C. to 300° C., 125° C. to 275° C., 125° C. to 250° C., 125° C. to 250° C., 125° C. to 225° C., 125° C. to 200° C., 125° C. to 175° C., 125° C. to 150° C., 150° C. to 400° C., 150° C. to 350° C., 150° C. to 250° C., or 150° C. to 200° C.

In an embodiment, the temperature of steam is between: 100° C. to 500° C., 100° C. to 400° C., between 100° C. to 300° C., 100° C. to 200° C., 100° C. to 150° C., 150° C. to 500° C., 150° C. to 400° C., 150° C. to 350° C., 150° C. to 300° C., 150° C. to 250° C., 150° C. to 200° C., 200° C. to 500° C., 200° C. to 400° C., 200° C. to 350° C., 200° C. to 300° C., 200° C. to 250° C., 250° C. to 500° C., 250° C. to 400° C., 250° C. to 350° C., 250° C. to 300° C., 300° C. to 500° C., 300° C. to 400° C., 300° C. to 350° C., or 350° C. to 400° C.

In one embodiment, the amount of steam that is applied during the heat treatment process is between: 0.5% to 20% by weight of the beans. For example, if 100 kg of beans are heat treated, between 0.5 kg and 20 kg of steam is added before, during or after heat treatment. In an embodiment, the amount of steam by weight of beans is between: 0.5% to 20%, 0.5% to 18%, 0.5% to 15%, 0.5% to 13%, 0.5% to 10%, 0.5% to 9%, 0.5% to 8%, 0.5% to 7%, 0.5% to 6%, 0.5% to 5%, 0.5% to 4%, 0.5% to 3%, 0.5% to 2%, 0.5% to 1%, 1% to 18%, 1% to 15%, 1% to 13%, 1% to 10%, 1% to 9%, 1% to 8%, 1% to 7%, 1% to 6%, 1% to 5%, 1% to 4%, 1% to 3%, 1% to 2%, 2% to 18%, 2% to 15%, 2% to 13%, 2% to 10%, 2% to 9%, 2% to 8%, 2% to 7%, 2% to 6%, 2% to 5%, 2% to 4%, 2% to 3%, 5% to 18%, 5% to 15%, 5% to 13%, 5% to 10%, 5% to 9%, 5% to 8%, 5% to 7%, or 5% to 6%.

In one embodiment, the time that the pulses are exposed to heat and/or steam in the one or more heating zones, also known as residence time, is between: 5 seconds and 30 minutes 1 minute and 25 minutes, between 1 minute and 20 minutes, between 1 minute and 15 minutes, between 1 minute and 10 minutes, between 1 minute and 8 minutes, between 1 minute and 7 minutes, between 1 minute and 6 minutes, between 1 minute and 5 minutes, between 1 minute and 4 minutes, between 1 minute and 3 minutes, between 1 minute and 2 minutes, between 2 minutes and 30 minutes, between 2 minutes and 20 minutes, between 2 minutes and 20 minutes, between 2 minutes and 5 minutes, between 3 minutes and 30 minutes, between 3 minutes and 20 minutes, between 3 minutes and 10 minutes, between 3 minutes and 5 minutes, between 5 minutes and 30 minutes, between 5 minutes and 30 minutes, between 5 minutes and 30 minutes, between 5 minutes and 30 minutes, between 5 minutes and 20 minutes, or between 5 minutes and 10 minutes.

In one embodiment, the temperature of the one or more cooling zones is individually at ambient temperature, between: 10° C. to 75° C., 10° C. to 70° C., 10° C. to 60° C., 10° C. to 50° C., 10° C. to 40° C., 10° C. to 30° C., 10° C. to 20° C., 20° C. to 100° C., 20° C. to 75° C., 20° C. to 50° C., 20° C. to 40° C., or 20° C. to 30° C., 30° C. to 70° C., 30° C. to 60° C., 30° C. to 50° C., 30° C. to 40° C.

In one embodiment, the time that the pulses are exposed to the one or more cooling zones, also known as residence time, is between: 5 seconds and 60 minutes, 5 seconds and 50 minutes, 5 seconds and 40 minutes, 5 seconds and 30 minutes, 5 seconds and 25 minutes, 5 seconds and 20 minute, 5 seconds and 15 minutes, 5 seconds and 10 minutes, 5 seconds and 5 minutes, 5 seconds and 3 minutes, 5 seconds and 2 minutes, 5 seconds and 1 minute, 10 seconds and 60 minutes, 10 seconds and 50 minutes, 10 seconds and 40 minutes, 10 seconds and 30 minutes, 10 seconds and 25 minutes, 10 seconds and 20 minute, 10 seconds and 15 minutes, 10 seconds and 10 minutes, 10 seconds and 5 minutes, 10 seconds and 3 minutes, 10 seconds and 2 minutes, 10 seconds and 1 minute, 30 seconds and 60 minutes, 30 seconds and 50 minutes, 30 seconds and 40 minutes, 30 seconds and 30 minutes, 30 seconds and 25 minutes, 30 seconds and 20 minute, 30 seconds and 15 minutes, 30 seconds and 10 minutes, 30 seconds and 5 minutes, 30 seconds and 3 minutes, 30 seconds and 2 minutes, 30 seconds and 1 minute, 40 seconds and 60 minutes, 40 seconds and 50 minutes, 40 seconds and 40 minutes, 40 seconds and 30 minutes, 40 seconds and 25 minutes, 40 seconds and 20 minute, 40 seconds and 15 minutes, 40 seconds and 10 minutes, 40 seconds and 5 minutes, 40 seconds and 3 minutes, 40 seconds and 2 minutes, 40 seconds and 1 minute, 50 seconds and 60 minutes, 50 seconds and 50 minutes, 50 seconds and 40 minutes, 50 seconds and 30 minutes, 50 seconds and 25 minutes, 50 seconds and 20 minute, 50 seconds and 15 minutes, 50 seconds and 10 minutes, 50 seconds and 5 minutes, 50 seconds and 3 minutes, 50 seconds and 2 minutes, 50 seconds and 1 minute, 1 minute and 60 minutes, 1 minute and 50 minutes, 1 minute and 40 minutes, 1 minute and 30 minutes, 1 minute and 20 minutes, 1 minute and 10 minutes, 1 minute and 5 minutes, 2 minutes and 60 minutes, 2 minutes and 50 minutes, 2 minutes and 40 minutes, 2 minutes and 30 minutes, 2 minutes and 20 minutes, 2 minutes and 10 minutes, 2 minutes and 5 minutes, 3 minutes and 30 minutes, 3 minutes and 20 minutes, 3 minutes and 20 minutes, 3 minutes and 10 minutes, 3 minutes and 5 minutes, or 3 minutes and 4 minutes.

In one embodiment, the methods disclosed are used to wet-mill pulses to produce wet-milled pulse flour. The pulse is selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soybeans, and mucuna beans. In an embodiment, the wet-milled, heat-treated pulse is of the genus Vigna. In another embodiment, the wet-milled pulse is of the species Vigna radiata or Vigna radiata.

Methods of Isolating Pulse Proteins

The present disclosure includes methods of preparing pulse protein isolates (e.g., mung bean protein isolates) using ultrafiltration techniques or by isoelectric precipitation. The pulse protein isolates prepared by these methods have characteristics that are advantageous for the preparation of food product compositions, as discussed in greater detail below.

An exemplary embodiment of a method for producing pulse protein isolates is through ultrafiltration. In one embodiment of ultrafiltration (UF) protein isolation, wet-milled pulse is ultrafiltered to produce hydrated pulse. (The wet-milled pulse is then subjected to protein extraction by in an aqueous solution. Starch solids are separated from the wet-milled pulse slurry to produce a protein-rich fraction. The protein-rich fraction is then introduced into an ultrafiltration process) to produce a purified protein.

In some embodiments, the methods for producing the pulse protein isolate comprise (a) extracting protein from a the wet-milled pulse comprising pulse proteins in an aqueous solution at a pH of from about 1 to about 9 to produce a protein rich fraction containing extracted pulse proteins, (b) applying the protein rich fraction to an ultrafiltration process comprising a semi-permeable membrane to separate a retentate fraction from a permeate fraction based on molecular size at a temperature of from about 5° C. to about 60° C., (c) collecting the retentate fraction containing the pulse protein isolate. In various embodiments, the methods may further comprise: dehulling and milling pulses to produce the milled composition comprising pulse proteins; drying the pulses prior to milling; adjusting the pH and/or conductivity of the retentate fraction; heating the retentate fraction to pasteurize the pulse proteins; and/or removing water or drying the retentate fraction and/or the pulse protein isolate.

In various embodiments, the pulse proteins may be isolated from any the wet-milled pulse, including dry beans, lentils, faba beans, dry peas, chickpeas, cowpeas, bambara beans, pigeon peas, lupins, vetches, adzuki, common beans, fenugreek, long beans, lima beans, runner beans, tepary beans, soy beans, or mucuna beans. In various embodiments, the pulse proteins may be isolated from Vigna angularis, Vicia faba, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse proteins are isolated from mung beans (Vigna radiata). In other embodiments, the milled composition may comprise almonds and other nuts, seeds such as sesame seeds, sunflower seeds, and other commonly consumed nuts, fruits and seeds.

In various embodiments, the methods discussed above or herein produce a pulse protein isolate comprising pulse proteins having a molecular size of less than 100 kilodaltons (kDa). In some embodiments, the methods produce a pulse protein isolate comprising pulse proteins having a molecular size of less than 95 kDa, 90 kDa, 85 kDa, 80 kDa, 75 kDa, 70 kDa, 65 kDa, 60, kDa, 55 kDa, 50 kDa, 45 kDa, 40 kDa, 35 kDa, 30 kDa, 25 kDa, 20 kDa, or 15 kDa. In various embodiments, the methods produce a pulse protein isolate comprising pulse proteins having a molecular size of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 kDa. Unless otherwise noted, references to a pulse protein isolate comprising pulse proteins having a specified molecular weight does not exclude the possibility that the same pulse protein isolate also contains pulse proteins of other molecular weights.

In various embodiments, the methods discussed above or herein produce a pulse protein isolate comprising pulse proteins enriched in proteins having a molecular size of greater than 5 kilodaltons (kDa). In some embodiments, the methods produce a pulse protein isolate comprising pulse proteins enriched in proteins having a molecular size of greater than 10 kDa, 15 kDa, 20 kDa, 25 kDa, 30 kDa, 35 kDa, 40 kDa, 45 kDa, 50 kDa, 55 kDa, 60 kDa, 65 kDa, 70 kDa, 75 kDa, 80 kDa, 85 kDa, 90 kDa, or 95 kDa. Unless otherwise noted, references to a pulse protein isolate comprising pulse proteins having a specified molecular weight does not exclude the possibility that the same pulse protein isolate or retentate fraction also contains pulse proteins of other molecular weights.

In various embodiments, the methods discussed above or herein produce a pulse protein isolate having a storage modulus of from 25 Pa to 500 Pa at a temperature between 90° C. and 95° C., as measured by dynamic oscillatory rheology using a rheometer equipped with a flat parallel plate geometry of 40 mm in which the measured pulse protein isolate comprises 12% w/w protein and the storage modulus is recorded under 0.1% strain conditions at a constant angular frequency of 10 rad/s. In various embodiments, the methods discussed above or herein produce a pulse protein isolate having a storage modulus of less than 50 Pa at a temperature between 90° C. and 95° C., as measured by dynamic oscillatory rheology using a rheometer equipped with a flat parallel plate geometry of 40 mm in which the measured pulse protein isolate comprises 12% w/w protein and the storage modulus is recorded under 0.1% strain conditions at a constant angular frequency of 10 rad/s.

In various embodiments, the methods discussed above or herein produce a pulse protein isolate having a linear viscoelastic region of from 25 Pa to 1500 Pa at up to 10% strain, as measured by dynamic oscillatory rheology using a rheometer equipped with a flat parallel plate geometry of 40 mm in which the measured pulse protein isolate comprises 12% w/w protein and the strain is carried out at a constant frequency of 10 rad/s at 50° C. In various embodiments, the methods discussed above or herein produce a pulse protein isolate having a linear viscoelastic region of less than 1000 Pa at up to 10% strain, as measured by dynamic oscillatory rheology using a rheometer equipped with a flat parallel plate geometry of 40 mm in which the measured pulse protein isolate comprises 12% w/w protein and the strain is carried out at a constant frequency of 10 rad/s at 50° C. In some embodiments, the methods produce a pulse protein isolate having a linear viscoelastic region of less than 500 Pa at up to 10% strain, or a linear viscoelastic region of less than 200 Pa at up to 10% strain.

Dehulling, Drying, and Milling

The pulse protein isolates (e.g., mung bean isolates) provided herein may be prepared from any suitable source of pulse protein, where the starting material is whole plant material (e.g., whole mung bean). In some cases, the methods may include dehulling the raw source material. In some such embodiments, raw pulse protein materials (e.g., mung beans) may be dehulled in one or more steps of pitting, soaking, and drying to remove the seed coat (husk) and pericarp (bran).

In an embodiment, wet-milled pulses are prepared from pulses that are not dehulled.

In an embodiment, wet-milled pulses are prepared from pulses that are dehulled. The pulse is dehulled by contacting the pulse with a solvent for a desired amount of time. In one embodiment, the solvent used for dehulling the pulse is water, ethanol, oil, or other solvents. Optionally, salts such as sodium salts, potassium salts, ammonium salts or other salts can be added to the solvent.

In one embodiment, the temperature of the solvent for dehulling is maintained at a temperature of between: 20° C. to 100° C., 20° C. to 95° C., 20° C. to 90° C., 20° C. to 85° C., 20° C. to 80° C., 20° C. to 75° C., 20° C. to 70° C., 20° C. to 65° C., 20° C. to 60° C., 20° C. to 55° C., 20° C. to 50° C., 20° C. to 45° C., 20° C. to 40° C., 20° C. to 35° C., 20° C. to 30° C., 20° C. to 25° C., 25° C. to 100° C., 25° C. to 95° C., 25° C. to 90° C., 25° C. to 85° C., 25° C. to 25° C., 25° C. to 75° C., 25° C. to 70° C., 25° C. to 65° C., 25° C. to 60° C., 25° C. to 55° C., 25° C. to 50° C., 25° C. to 45° C., 25° C. to 40° C., 25° C. to 35° C., 25° C. to 30° C., 30° C. to 40° C., 40° C. to 50° C., 50° C. to 60° C., 60° C. to 70° C., 70° C. to 80° C., 80° C. to 90° C., or 90° C. to 100° C.

In one embodiment, the time that the pulse is contacted with the solvent to remove the hull is between: 30 minutes to 24 hours, 30 minutes to 24 hours, 30 minutes to 20 hours, 30 minutes to 15 hours, 30 minutes to 10 hours, 30 minutes to 9 hours, 30 minutes to 8 hours, 30 minutes to 7 hours, 30 minutes to 6 hours, 30 minutes to 5 hours, 30 minutes to 4 hours, 30 minutes to 3 hours, 30 minutes to 2 hours, 30 minutes to 1 hour, 1 hour to 20 hours, 1 hour to 15 hours, 1 hour to 10 hours, 1 hour to 9 hours, 1 hour to 8 hours, 1 hour to 7 hours, 1 hour to 6 hours, 1 hour to 5 hours, 1 hour to 4 hours, 1 hour to 3 hours, 1 hour to 2 hours, 2 hours to 24 hours, 2 hours to 24 hours, 2 hours to 20 hours, 2 hours to 15 hours, 2 hours to 10 hours, 2 hours to 9 hours, 2 hours to 8 hours, 2 hours to 7 hours, 2 hours to 6 hours, 2 hours to 5 hours, 2 hours to 4 hours, or 2 hours to 3 hours.

The de-hulled material (e.g., mung beans in which the hulls have been removed) are then wet-milled to produce wet-milled pulse with a desired particle size distribution as discussed above. The types of mills employed may include one or a combination of a hammer, pin, knife, burr, impact, disc mill, shear mill, homogenizer and air classifying mills.

Air classification is an industrial process in which materials are separated by a combination of density, size and/or shape. Dried materials such as pulse flours, for example mung bean flour, are introduced into an air classifier (air elutriator) where the particles are subjected to a column of rising air. The less dense particles are carried further in the air stream and separation of particles by density is achieved. The applicant has discovered that less dense pulse particles contain higher amounts of protein than the particles with higher density.

Protein Extraction

The methods for producing the pulse protein isolate comprise extracting protein from a milled composition comprising pulse proteins in an aqueous solution at a pH of from about 1 to about 10 to produce a protein rich fraction containing extracted pulse proteins. In some embodiments, the aqueous solution has a pH of from about 4 to about 9. In some embodiments, the aqueous solution has a pH of from about 6 to about 10. In some embodiments, the aqueous solution has a pH of about 7 to about 9. In some embodiment, the aqueous solution has a pH of about 8. In various embodiments, the pH of the aqueous solution is about 1, 1.5, 2, 2.5, 3, 3.5, 4, 4.5, 5, 5.5, 6, 6.5, 7, 7.5, 8, 8.5, 9, 9.5, or 10. In some embodiments, the extraction is performed at a pH of 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, or 9.5. The pH of the slurry may be adjusted with, e.g., a food-grade 50% sodium hydroxide solution to reach the desired extraction pH.

In some embodiments of the extraction step, an intermediate starting material, for example, a milled composition comprising pulse proteins (e.g., mung bean flour), is mixed with an aqueous solution to form a slurry. In some embodiments, the aqueous solution is water, for example soft water. The aqueous extraction may include creating an aqueous solution comprising one part of the source of the plant protein (e.g., flour) to about, for example, 3 to 15 parts aqueous extraction solution. Additional useful solid:liquid ratios for extraction include 1:2, 1:3, 1:4, 1:5, 1:6, 1:7, 1:8, 1:9, 1:10, 1:11, 1:12, 1:13, 1:14, 1:15. In some embodiments, extraction is performed using a solid:liquid ratio of 1:6.

In some cases, the aqueous extraction is performed at a desired temperature, for example, about 2-10° C. in a chilled mix tank to form the slurry. In some embodiments, the mixing is performed under moderate to high shear. In some embodiments, a food-grade de-foaming agent (e.g., KFO 402 Polyglycol) is added to the slurry to reduce foaming during the mixing process. De-foamers include, but are not limited to, polyglycol based de-foamers, vegetable oil based de-foamers, and silicone. In other embodiments, a de-foaming agent is not utilized during extraction.

Following extraction, the protein rich fraction may be separated from the slurry, for example, in a solid/liquid separation unit, consisting of a decanter and a disc-stack centrifuge. The protein rich fraction may be centrifuged at a low temperature, e.g., between 3-10° C. In some cases, the protein rich fraction is collected and the pellet is resuspended in, e.g., 3:1 water-to-protein. The process may be repeated, and the combined protein rich fractions filtered through a Nylon mesh.

Starch Solids Separation

In some embodiments, the methods may optionally include reducing or removing a fraction comprising carbohydrates (e.g., starches) or a carbohydrate-rich protein isolate, post extraction.

Charcoal Treatment

Optionally, the protein rich fraction, retentate fraction, or pulse protein isolate may be subjected to a carbon adsorption step to remove non-protein, off-flavor components, and additional fibrous solids from the protein extraction. This carbon adsorption step leads to a clarified protein extract. In one embodiment of a carbon adsorption step, the protein extract is then sent through a food-grade granular charcoal-filled annular basket column (<5% w/w charcoal-to-protein extract ratio) at 4 to 8° C.

Ultrafiltration

The methods of the present disclosure may utilize ultrafiltration to separate the pulse proteins from other materials. The ultrafiltration process utilizes at least one semi-permeable selective membrane that separates a retentate fraction (containing materials that do not pass through the membrane) from a permeate fraction (containing materials that do pass through the membrane). The semi-permeable membrane separates materials (e.g., proteins and other components) based on molecular size. For example, the semi-permeable membrane used in the ultrafiltration processes of the present methods may exclude molecules (i.e., these molecules are retained in the retentate fraction) having a molecular size of 10 kDa or larger. In some embodiments, the semi-permeable membrane may exclude molecules (e.g., pulse proteins) having a molecular size of 25 kDa or larger. In some embodiments, the semi-permeable membrane excludes molecules having a molecular size of 50 kDa or larger. In various embodiments, the semi-permeable membrane used in the ultrafiltration process of the methods discussed herein excludes molecules (e.g., pulse proteins) having a molecular size greater than 5 kDa, 10 kDa, 15 kDa, 20 kDa, 25 kDa, 30 kDa, 35 kDa, 40, kDa, 45 kDa, 50 kDa, 55 kDa, 60 kDa, 65 kDa, 70 kDa, 75 kDa, 80 kDa, 85 kDa, 90 kDa, or 95 kDa. For example, a 10 kDa membrane allows molecules, including pulse proteins, smaller than 10 kDa in size to pass through the membrane into the permeate fraction, while molecules, including pulse proteins, equal to or larger than 10 kDa are retained in the retentate fraction. An exemplary protocol for the ultrafiltration process is provided in Example 1.

Ultrafiltration (UF) is a cross-flow separation process for separating compounds with particular molecular weights that are present in a liquid. By applying pressure, typically in the range of 20-500 psig to a membrane, the compounds having the specified molecular weight are separated from the liquid. UF membranes have molecular weight cut-off ranges of 1,000 to 500,000 Da. The pore sizes of the membranes typically range between 0.1 to 0.001 micron. The nominal pore size of a UF membrane with a 100 kDa cut-off is typically about 0.006 micron and a membrane with a 10 kDa cut-off is typically about 0.003 micron. If a liquid solution containing proteins, e.g., mung bean proteins, is subjected to ultrafiltration using a 10 kDa membrane, the concentration of proteins having a molecular weight of less than 10 kDa is increased in the filtrate (permeate) and decreased in the retentate. Concomitantly, the concentration of proteins having a molecular weight of greater than 10 kDa is increased in the retentate and decreased in the filtrate (permeate). In various embodiments of the methods discussed herein, the semi-permeable membrane may have a pore size of 0.001, 0.0015, 0.002, 0.0025, 0.003, 0.0035, 0.004, 0.0045, 0.005, 0.0055, or 0.006 micron.

There are various types of UF membranes that are available commercially, including polymeric, ceramic, and metallic membranes having a desired molecular weight cutoff. For polymeric membrane types, these include membranes made from polyvinylidine fluoride (PVDF), polyether sulfone (PES), polyacrylonitrile (PAN), polytetrafluoroethylene (PTFE), polyamide-imide (PAI) and natural polymers including membranes made from rubber, wool, and cellulose. Metallic membranes are made by sintering metal powders onto a porous substrate. Commonly used metal powders are stainless steel, tungsten and palladium. Ceramic membranes are made of oxides, nitrides or carbides of metallic (e.g., aluminum and titanium) and non-metallic materials. UF membranes comprising zeolites are made of hydrated aluminosilicate minerals that contain alkali and alkaline-earth metals. Zeolite UF membranes are useful because of their highly uniform pore size.

The ultrafiltration process of the present methods may be performed at a temperature in a range of from about 5° C. to about 60° C. In some cases, the temperature may be about 15° C., about 20° C., about 25° C., about 30° C., about 35° C., about 40° C., about 45° C., or about 50° C. In some embodiments, the ultrafiltration process is performed at a pressure of from about 20 to about 500 psig. In various embodiments, the ultrafiltration process is performed at a pressure of about 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 psig.

pH and Conductivity Adjustment

In some embodiments, the methods include adjusting the pH and/or conductivity of the retentate fraction or the pulse protein isolate. In some cases, the pH is adjusted to a range of from about 5.8 to about 6.6. In some embodiment, the pH is adjusted to from 6.0 to 6.2. In various embodiments, the pH is adjusted to 5.8, 5.9, 6.0, 6.1, 6.2, 6.3, 6.4, 6.5, or 6.6. In some embodiments, the conductivity of the retentate fraction or the pulse protein isolate is adjusted. In some embodiments, the conductivity of the retentate fraction or the pulse protein isolate is adjusted to between 1-3 mS/cm using salt if required. In various embodiments, the conductivity is adjusted to 1, 1.1, 1.2, 1.3, 1.4, 1.5, 1.6, 1.7, 1.8, 1.9, 2.0 2.1, 2.2, 2.3, 2.4, 2.5, 2.6, 2.7, 2.8, 2.9, or 3.0 mS/cm. In various embodiments, the salt used to modify the conductivity can be selected from sodium chloride, sodium sulfate, sodium phosphate, ammonium sulfate, ammonium phosphate, ammonium chloride, potassium chloride, potassium sulfate, or potassium phosphate. In some embodiments, the salt is NaCl.

In some embodiments, the methods include adjusting the pH and/or conductivity of the retentate fraction or the pulse protein isolate in two or more pH adjustment steps. In some cases, the pH is adjusted to a first pH range of from about 4.0 to about 6.6. Next, a second pH adjustment is made in which the pH of the retentate fraction or the pulse protein isolate is adjusted to be different, that is higher or lower, than the first pH of the retentate fraction or the pulse protein isolate. In some embodiments, the first pH adjustment is made to a pH of 4.0 to 6.0. In some embodiments, the pH achieved in the second pH adjustment is between 5.0 and 6.6. In various embodiments, the first pH is adjusted to 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0. In various embodiments, the second pH is adjusted to 5.0, 5.1, 5.2, 5.3, 5.4, 5.5, 5.6, 5.7, 5.8, 5.9, 6.0, 6.1, 6.2, 6.3, 6.4, 6.5, or 6.6. In various embodiments, the conductivity is adjusted to 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 mS/cm. In various embodiments, the salt used to modify the conductivity can be selected from sodium chloride, sodium sulfate, sodium phosphate, ammonium sulfate, ammonium phosphate, ammonium chloride, potassium chloride, potassium sulfate, or potassium phosphate. In some embodiments, the salt is NaCl.

Pasteurization and Drying

In some embodiments, the methods include heating the retentate fraction or the pulse protein isolate in a pasteurization process and/or drying the retentate fraction or the pulse protein isolate. In some embodiments, the retentate fraction or the pulse protein isolate is heated to a temperature of from about 70° C. to about 80° C. for a period of time (e.g., 20-30 seconds) to kill pathogens (e.g., bacteria). In a particular embodiment, pasteurization is performed at 74° C. for 20 to 23 seconds. In particular, embodiments where a dry pulse protein isolate is desired, the pulse protein isolate may be passed through a spray dryer to remove any residual water content. The typical spray drying conditions include an inlet temperature of 170° C. and an outlet temperature of 70° C. The final dried protein isolate powder may comprise less than 10% or less than 5% moisture content.

Order of Steps and Additional Steps

It is to be understood that the steps of the methods discussed above or herein may be performed in alternative orders consistent with the objective of producing a pulse protein isolate. In some embodiments, the methods may include additional steps, such as for example: recovering the purified protein isolate (e.g., using centrifugation), washing the purified protein isolate, making a paste using the purified protein isolate, or making a powder using the purified protein isolate. In some embodiments, the purified protein isolate is rehydrated (e.g., to about 80% moisture content), and the pH of the rehydrated purified protein isolate is adjusted to a pH of about 6. Unless otherwise noted, none of the embodiments discussed herein include isoelectric precipitation of the pulse proteins from a protein rich fraction (e.g., at a pH of from about 5 to about 6).

Pulse Protein Isolates

The present disclosure includes pulse protein isolates (e.g., mung bean protein isolates), including those prepared by the methods discussed above. The pulse protein isolates are edible and comprise one or more desirable food qualities, including but limited to, high protein content, high protein purity, reduced retention of small molecular weight non-protein species (including mono and disaccharides), reduced retention of oils and lipids, superior structure building properties such as high gel strength and gel elasticity, superior sensory properties, and selective enrichment of highly functional 8s globulin/beta conglycinin proteins.

In various embodiments, the pulse protein isolates provided herein are derived from dry beans, lentils, faba beans, dry peas, chickpeas, cowpeas, bambara beans, pigeon peas, lupins, vetches, adzuki, common beans, fenugreek, long beans, lima beans, runner beans, or tepary beans, soybeans, or mucuna beans. In various embodiments, the pulse protein isolates provided herein are derived from Vigna angularis, Vicia faba, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse protein isolates are derived from mung beans. In some embodiments, the mung bean is Vigna radiata. In other embodiments, the milled composition may comprise almonds and other nuts, seeds such as sesame seeds, sunflower seeds, and other commonly consumed nuts, fruits and seeds. In various embodiments, the pulse protein isolate (e.g., mung bean protein isolate) discussed herein can be produced from any source of pulse protein (e.g., mung bean protein, including any varietal or cultivar of V. radiata). For example, the protein isolate can be prepared directly from whole plant material such as whole mung bean, or from an intermediate material made from the plant, for example, a dehulled bean, a non-dehulled bean, a flour, an air classified flour, a powder, a meal, ground grains, a cake (such as, for example, a defatted or de-oiled cake), or any other intermediate material suitable to the processing techniques disclosed herein to produce a pulse protein isolate. In some embodiments, the source of the plant protein may be a mixture of two or more intermediate materials. The examples of intermediate materials provided herein are not intended to be limiting.

Characteristics of the Pulse Protein Isolates

In various embodiments, the pulse protein isolate (e.g., mung bean protein isolate) comprises pulse protein of from 50% to 60%, from 60% to 70%, from 70% to 80%, from 80% to 90%, or more. In some embodiments, the pulse protein isolate comprises 80%, 81%, 82%, 83%, 84%, 85%, 86%, 87%, 88%, 89%, 90%, 91%, 92%, 93%, 94%, 95%, 96%, 97%, 98%, or 99% or more pulse proteins. In some embodiments, at least 60% by weight of the pulse protein isolate is comprised of pulse proteins. In some embodiments, at least 65%, 70%, 75%, 80%, 85%, 90%, or 95% or more by weight of the pulse protein isolate comprises pulse proteins.

In some embodiments in which the pulse protein is mung bean protein, at least about 10%, 15%, 20%, 25%, 30%, 35%, 40%, 45%, 50%, 55%, 60%, 65%, 70%, 75%, 80%, 85%, or greater than 85% by weight of the mung bean protein isolate consists of or comprises mung bean 8s globulin/beta-conglycinin. In other embodiments, about 60% to 80%, 65% to 85%, 70% to 90%, or 75% to 95% by weight of the mung bean protein isolate consists of or comprises mung bean 8s globulin/beta-conglycinin. In some embodiments, the mung bean protein isolate is reduced in the amount of 11s globulin relative to whole mung bean or mung bean flour. In some embodiments, the amount of 11s globulin is less than 10%, 8%, 8%, 7%, 6%, 5%, 4%, 3%, 2%, or 1% of the protein in the mung bean protein isolate.

In some embodiments, the pulse protein isolate (e.g., mung bean protein isolate) comprises about 1% to 10%, 2% to 9%, 3% to 8%, or 4% to 6% of carbohydrates (e.g., starch, polysaccharides, fiber) derived from the plant source of the isolate. In some embodiments, the pulse protein isolate comprises less than about 10%, 9%, 8%, 7%, 6%, or 5% of carbohydrates derived from the plant source of the isolate. In some embodiments, the pulse protein isolate comprises about 9%, 8%, 7%, 6%, 5%, 4%, 3%, 2%, or about 1% of carbohydrates derived from the plant source of the isolate.

In some embodiments, the pulse protein isolate (e.g., mung bean protein isolate) comprises about 1% to 10%, 2% to 9%, 3% to 8%, or 4% to 6% of ash derived from the plant source of the isolate. In some embodiments, the pulse protein isolate comprises less than about 10%, 9%, 8%, 7%, 6%, or 5% of ash derived from the plant source of the isolate. In some embodiments, the pulse protein isolate comprises about 9%, 8%, 7%, 6%, 5%, 4%, 3%, 2%, or about 1% of ash derived from the plant source of the isolate.

In some embodiments, the pulse protein isolate (e.g., mung bean protein isolate) comprises about 1% to 10%, 2% to 9%, 3% to 8%, or 4% to 6% of fats derived from the plant source of the isolate. In some embodiments, the pulse protein isolate comprises less than about 10%, 9%, 8%, 7%, 6%, or 5% of fats derived from the plant source of the isolate. In some embodiments, the pulse protein isolate comprises about 9%, 8%, 7%, 6%, 5%, 4%, 3%, 2%, or about 1% of fats derived from the plant source of the isolate.

In some embodiments, the pulse protein isolate (e.g., mung bean protein isolate) comprises about 1% to 10% of moisture derived from the plant source of the isolate. In some embodiments, the pulse protein isolate comprises less than about 10%, 9%, 8%, 7%, 6%, or 5% of moisture derived from the plant source of the isolate. In some embodiments, the pulse protein isolate comprises about 9%, 8%, 7%, 6%, 5%, 4%, 3%, 2%, or about 1% of moisture derived from the plant source of the isolate.

In various embodiments, the pulse protein isolate (e.g., mung bean protein isolate) comprises pulse proteins having a molecular size of less than 100 kilodaltons (kDa). In some embodiments, the pulse protein isolate comprises pulse proteins having a molecular size of less than 95 kDa, 90 kDa, 85 kDa, 80 kDa, 75 kDa, 70 kDa, 65 kDa, 60, kDa, 55 kDa, 50 kDa, 45 kDa, 40 kDa, 35 kDa, 30 kDa, 25 kDa, 20 kDa, or 15 kDa. In various embodiments, the pulse protein isolate comprises pulse proteins having a molecular size of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 kDa. Unless otherwise noted, references to a pulse protein isolate comprising pulse proteins having a specified molecular weight does not exclude the possibility that the same pulse protein isolate or retentate fraction also contains pulse proteins of other molecular weights.

In various embodiments, the pulse protein isolate (e.g., mung bean protein isolate) comprises pulse proteins enriched in proteins having a molecular size of greater than 5 kilodaltons (kDa). In some embodiments, the pulse protein isolate comprises pulse proteins enriched in proteins having a molecular size of greater than 10 kDa, 15 kDa, 20 kDa, 25 kDa, 30 kDa, 35 kDa, 40 kDa, 45 kDa, 50 kDa, 55 kDa, 60 kDa, 65 kDa, 70 kDa, 75 kDa, 80 kDa, 85 kDa, 90 kDa, or 95 kDa. In some embodiments, the pulse protein isolated comprises pulse proteins enriched in proteins having a molecular size of less than 100 kDa. In some embodiments, the pulse protein isolate (e.g., mung bean protein isolate) comprises pulse proteins enriched in proteins having a molecular size of from 1 kDa to 99 kDa, from 1 kDa to 75 kDa, from 1 kDa to 50 kDa, from 1 kDa to 25 kDa, from 5 kDa to 99 kDa, from 5 kDa to 75 kDa, from 5 kDa to 50 kDa, from 5 kDa to 25 kDa, from 10 kDa to 99 kDa, from 10 kDa to 75 kDa, from 10 kDa to 50 kDa, or from 10 kDa to 25 kDa. In various embodiments, the pulse protein isolate comprises, or is enriched in, pulse proteins having a molecular size of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 kDa. Unless otherwise noted, references to a pulse protein isolate (or retentate fraction) comprising pulse proteins having a specified molecular weight does not exclude the possibility that the same pulse protein isolate or retentate fraction also contains pulse proteins of other molecular weights.

In various embodiments, the pulse protein isolate (e.g., mung bean protein isolate) comprises pulse proteins depleted in proteins having a molecular size of less than 5 kilodaltons (kDa). In some embodiments, the pulse protein isolate comprises pulse proteins depleted in proteins having a molecular size of less than 10 kDa, 15 kDa, 20 kDa, 25 kDa, 30 kDa, 40 kDa, 45 kDa, 50 kDa, 55 kDa, 60 kDa, 65 kDa, 70 kDa, 80 kDa, 85 kDa, 95 kDa, or 95 kDa. In various embodiments, the pulse protein isolate comprises, or is enriched in, pulse proteins having a molecular size of 99, 98, 97, 96, 95, 94, 93, 92, 91, 90, 89, 88, 87, 86, 85, 84, 83, 82, 81, 80, 79, 78, 77, 76, 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 kDa. Unless otherwise noted, references to a pulse protein isolate comprising pulse proteins having a specified molecular weight does not exclude the possibility that the same pulse protein isolate or retentate fraction also contains pulse proteins of other molecular weights.

Reduced Allergen, Anti-Nutritional, and Environmental Contaminant Content

In some embodiments, the pulse protein isolates (e.g., mung bean protein isolate) provided herein have a reduced allergen content. In some embodiments, the reduced allergen content is relative to the allergen content of the plant source of the isolate. The pulse protein isolate or a composition comprising the pulse protein isolate may be animal-free, dairy-free, soy-free and gluten-free. Adverse immune responses such as hives or rash, swelling, wheezing, stomach pain, cramps, diarrhea, vomiting, dizziness and even anaphylaxis presented in subjects who are typically allergic to eggs may be averted. Further, the pulse protein isolate or a composition comprising the pulse protein isolate may not trigger allergic reactions in subjects based on milk, eggs, soy and wheat allergens. Accordingly, in some embodiments, the pulse protein isolate or a composition comprising the pulse protein isolate is substantially free of allergens.

Dietary anti-nutritional factors are chemical substances that can adversely impact the digestibility of protein, bioavailability of amino acids and protein quality of foods (Gilani et al., 2012). In some embodiments, the pulse protein isolates (e.g., mung bean protein isolates) provided herein have reduced amounts of anti-nutritional factors. In some embodiments, the reduced amount of anti-nutritional factors is relative to the content of the plant source of the isolate. In some embodiments, the reduced anti-nutritional factor is selected from the group consisting of tannins, phytic acid, hemagglutinins (lectins), polyphenols, trypsin inhibitors, α-amylase inhibitors, lectins, protease inhibitors, and combinations thereof.

In various embodiments, environmental contaminants are either free from the pulse protein isolates (e.g., mung bean protein isolates), below the level of detection of 0.1 ppm, or present at levels that pose no toxicological significance. In some embodiments, the reduced environmental contaminant is a pesticide residue. In some embodiments, the pesticide residue is selected from the group consisting of: chlorinated pesticides, including alachlor, aldrin, alpha-BHC, alpha-chlordane, beta-BHC, DDD, DDE, DDT, delta-BHC, dieldrin, endosulfan I, endosulfan II, endosulfan sulfate, endrin, endrin aldehyde, gamma-BHC, gamma-chlordane, heptachlor, heptachlor epoxide, methoxyclor, and permethrin; and organophosphate pesticides including azinophos methyl, carbophenothion, chlorfenvinphos, chlorpyrifos methyl, diazinon, dichlorvos, dursban, dyfonate, ethion, fenitrothion, malathion, methidathion, methyl parathion, parathion, phosalone, pirimiphos methyl, and combinations thereof. In some embodiments, the reduced environmental contaminant is selected from residues of dioxins and polychlorinated biphenyls (PCBs), or mycotoxins such as aflatoxin B1, B2, G1, G2, and ochratoxin A.

Other Food Functionality Characteristics of the Pulse Protein Isolates

In various embodiments, the pulse protein isolates (e.g., mung bean protein isolates) exhibit desirable functional characteristics such as emulsification, water binding, foaming and gelation properties comparable to an egg. In various embodiments, the pulse protein isolates exhibit one or more functional properties advantageous for use in food compositions. The functional properties may include, but are not limited to, crumb density, structure/texture, elasticity/springiness, coagulation, binding, moisturizing, mouthfeel, leavening, aeration/foaming, creaminess, and emulsification of the food composition. Mouthfeel is a concept used in the testing and description of food products. Products made using pulse protein isolates discussed herein can be assessed for mouthfeel. Products, e.g., baked goods, made using the pulse protein isolates have mouthfeel that is similar to products made with natural eggs. In some embodiments, the mouthfeel of the products made using the pulse protein isolates is superior to the mouthfeel of previously known or attempted egg substitutes, e.g., bananas, modified whey proteins, or Egg Beaters™.

Examples of properties which may be included in a measure of mouthfeel include: Cohesiveness: degree to which the sample deforms before rupturing when biting with molars; Density: compactness of cross section of the sample after biting completely through with the molars; Dryness: degree to which the sample feels dry in the mouth; Fracturability: force with which the sample crumbles, cracks or shatters (fracturability encompasses crumbliness, crispiness, crunchiness and brittleness); Graininess: degree to which a sample contains small grainy particles, may be seen as the opposite of smoothness; Gumminess: energy required to disintegrate a semi-solid food to a state ready for swallowing; Hardness: force required to deform the product to given distance, i.e., force to compress between molars, bite through with incisors, compress between tongue and palate; Heaviness: weight of product perceived when first placed on tongue; Moisture absorption: amount of saliva absorbed by product; Moisture release: amount of wetness/juiciness released from sample; Mouthcoating: type and degree of coating in the mouth after mastication (for example, fat/oil); Roughness: degree of abrasiveness of product's surface perceived by the tongue; Slipperiness: degree to which the product slides over the tongue; Smoothness: absence of any particles, lumps, bumps, etc., in the product; Uniformity: degree to which the sample is even throughout; homogeneity; Uniformity of Bite: evenness of force through bite; Uniformity of Chew: degree to which the chewing characteristics of the product are even throughout mastication; Viscosity: force required to draw a liquid from a spoon over the tongue; and Wetness: amount of moisture perceived on product's surface.

The pulse protein isolates discussed herein may also have one or more functional properties alone or when incorporated into a food composition. Such functional properties may include, but are not limited to, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, at least one functional property of the pulse protein isolate differs from the corresponding functional property of the source of the plant protein. In some embodiments, at least one functional property of the pulse protein isolate (alone or when incorporated into a food composition) is similar or equivalent to the corresponding functional property of a reference food product, such as, for example, an egg (liquid, scrambled, or in patty form), a cake (e.g., pound cake, yellow cake, or angel food cake), a cream cheese, a pasta, an emulsion, a confection, an ice cream, a custard, milk, a deli meat, chicken (e.g., chicken nuggets), or a coating. In some embodiments, the pulse protein isolate, either alone or when incorporated into a composition, is capable of forming a gel under heat or at room temperature.

Modified Organoleptic Properties

The pulse protein isolates discussed herein may have modulated organoleptic properties of one or more of the following characteristics: astringent, beany, bitter, burnt, buttery, nutty, sweet, sour, fruity, floral, woody, earthy, beany, spicy, metallic, sweet, musty, grassy, green, oily, vinegary, neutral and bland flavor or aromas. In some embodiments, the pulse protein isolates exhibit modulated organoleptic properties such as a reduction or absence in one or more of the following: astringent, beany, bitter, burnt, buttery, nutty, sweet, sour, fruity, floral, woody, earthy, beany, spicy, metallic, sweet, musty, grassy, green, oily, vinegary neutral and bland flavor or aromas.

In some cases, methods to reduce or remove at least one impurity that may impart or is associated with an off-flavor or off-odor in the pulse protein isolate may be undertaken. The one or more impurity may be a volatile or nonvolatile compound and may comprise, for example, lipoxygenase, which is known to catalyze oxidation of fatty acids. In other cases, the at least one impurity may comprise a phenol, an alcohol, an aldehyde, a sulfide, a peroxide, or a terpene. Other biologically active proteins classified as albumins may also be removed, including lectins and protease inhibitors such as serine protease inhibitors and tryptic inhibitors. In some embodiments, impurities are reduced by a solid absorption procedure using, for example, charcoal, a bentonite clay, or activated carbon.

In some embodiments, the at least one impurity may comprise one or more substrates for an oxidative enzymatic activity, for example one or more fatty acids. In some embodiments, the pulse protein isolates contain reduced amounts of one or more fatty acids selected from: C14:0 (methyl myristate); C15:0 (methyl pentadecanoate); C16:0 (methyl palmitate; C16:1 methyl palmitoleate; C17:0 methyl heptadecanoate; C18:0 methyl stearate; C18:1 methyl oleate; C18:2 methyl linoleate; C18:3 methyl alpha linoleate; C20:0 methyl eicosanoate; and C22:0 methyl behenate to reduce rancidity.

In some embodiments, the pulse protein isolate (e.g., mung bean protein isolate) has a reduced oxidative enzymatic activity relative to the source of the pulse protein. For example, a purified mung bean isolate can have about a 5%, 10%, 15%, 20%, or 25% reduction in oxidative enzymatic activity relative to the source of the mung bean protein. In some embodiments, the oxidative enzymatic activity is lipoxygenase activity. In some embodiments, the pulse protein isolate has lower oxidation of lipids or residual lipids relative to the source of the plant protein due to reduced lipoxygenase activity.

In additional embodiments, reducing the at least one impurity comprises removing a fibrous solid, a salt, or a carbohydrate. Reducing such impurity comprises removing at least one compound that may impart or is associated with the off-flavor or off-odor. Such compounds may be removed, for example, using an activated charcoal, carbon, or clay. As another example, the at least one compound may be removed using a chelating agent (e.g., EDTA, citric acid, or a phosphate) to inhibit at least one enzyme that oxidizes a lipid or a residual lipid. In a particular example, EDTA may be used to bind co-factor for lipoxygenase, an enzyme that can oxidize residual lipid to compounds, e.g. hexanal, which are known to leave to off-flavors.

Food Compositions Containing Pulse Protein Isolates

The pulse protein isolates (e.g., mung bean protein isolates) discussed herein may be incorporated into a food composition along with one or more other edible ingredients. In some cases, the pulse protein isolate may be used as a direct protein replacement of animal- or vegetable-based protein in a variety of conventional food and beverage products across multiple categories. In some embodiments, the use levels range from 3 to 90% w/w of the final product. Exemplary food compositions in which the pulse protein isolates can be used are discussed below. In some embodiments, the pulse protein isolate is used as a supplement to existing protein in food products. In any of the various embodiments of the food compositions, the pulse protein isolate may be contacted with a cross-linking enzyme to cross-link the pulse proteins. In various embodiments, the cross-linking enzyme is selected from transglutaminase, sortase, subtilisin, tyrosinase, laccase, peroxidase, or lysyl oxidase. In some embodiments, the cross-linking enzyme is transglutaminase. In any of the various embodiments of the food compositions, the pulse protein isolate may be contacted with a protein modifying enzyme such as papain, pepsin, rennet, coagulating enzymes or sulfhydryl oxidase to modify the structure of the pulse proteins.

The pulse protein isolates provided herein are suitable for various food applications and can be incorporated into, e.g., edible egg-free emulsion, egg analog, egg-free scrambled eggs, egg-free patty, egg-free pound cake, egg-free angel food cake, egg-free yellow cake, egg-free cream cheese, egg-free pasta dough, egg-free custard, egg-free ice cream, and dairy-free milk. The pulse protein isolates can also be used as replacement ingredients in various food applications including but not limited to meat substitutes, egg substitutes, baked goods and fortified drinks

In various embodiments, one or more pulse protein isolates can be incorporated into multiple food compositions, including liquid and patty scrambled egg substitutes to a desired level of emulsification, water binding and gelation. In an embodiment, a functional egg replacement product comprises pulse protein isolate (8-15%), and one or more of: oil (10%), hydrocolloid, preservative, and optionally flavors, water, lecithin, xanthan, sodium carbonate, and black salt.

In some embodiments, the pulse protein isolate is incorporated in an egg substitute composition. In some such embodiments, the organoleptic property of the pulse protein isolate (e.g., a flavor or an aroma) is similar or equivalent to a corresponding organoleptic property of an egg. The egg substitute composition may exhibit at least one functional property (e.g., emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color) that is similar or equivalent to a corresponding functional property of an egg. In addition to the pulse protein isolate, the egg substitute composition may include one or more of iota-carrageenan, gum arabic, konj ac, xanthan gum, or gellan.

In some embodiments, the pulse protein isolate is incorporated in an egg-free cake, such as a pound cake, a yellow cake, or an angel food cake. In some such embodiments, at least one organoleptic property (e.g., a flavor or an aroma) of the egg-free cake is similar or equivalent to a corresponding organoleptic property of a cake containing eggs. The egg-free cake may exhibit at least one functional property similar or equivalent to a corresponding functional property of a cake containing eggs. The at least one function property may be, for example, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, color, or a combination thereof. In some embodiments in which the pulse protein isolate is included in an egg-free pound cake, a peak height of the egg-free pound cake is at least 90% of the peak height of a pound cake containing eggs.

In some embodiments, the pulse protein isolate is incorporated into an egg-free cake mix or an egg-free cake batter. In some such embodiments, the egg-free cake mix or batter has at least one organoleptic property (e.g., a flavor or aroma) that is similar or equivalent to a corresponding organoleptic property of a cake mix or batter containing eggs. The egg-free cake mix or batter may exhibit at least one functional property similar or equivalent to a corresponding functional property of a cake batter containing eggs. The at least one functional property may be, for example, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, color, or a combination thereof. In some embodiments in which the pulse protein isolate is included in an egg-free pound cake batter, a specific gravity of the egg-free pound cake batter is 0.95-0.99.

In some cases, increased functionality is associated with the pulse protein isolate in a food composition. For instance, food products produced with the pulse protein isolates discussed herein may exhibit increased functionality in dome or crack, cake resilience, cake cohesiveness, cake springiness, cake peak height, specific gravity of batter, center doming, center crack, browning, mouthfeel, spring-back, off flavors or flavor.

In some embodiments, the pulse protein isolate is included in a cream cheese, a pasta dough, a pasta, a milk, a custard, a frozen dessert (e.g., a frozen dessert comprising ice cream), a deli meat, or chicken (e.g., chicken nuggets).

In some embodiments, the pulse protein isolate is incorporated into a food or beverage composition, such as, for example, an egg substitute, a cake (e.g., a pound cake, a yellow cake, or an angel food cake), a cake batter, a cake mix, a cream cheese, a pasta dough, a pasta, a custard, an ice cream, a milk, a deli meat, or a confection. The food or beverage composition may provide sensory impressions similar or equivalent to the texture and mouthfeel that replicates a reference food or beverage composition. In some embodiments, before being included in a food or beverage composition, the pulse protein isolate is further processed in a manner that depends on a target application for the pulse protein isolate. For example, the pulse protein isolate may be diluted in a buffer to adjust the pH to a pH appropriate for the target application. As another example, the pulse protein isolate may be concentrated for use in the target application. As yet another example, the pulse protein isolate may be dried for use in the target application. Various examples of food compositions comprising the pulse protein isolates discussed herein are provided below.

Scrambled Egg Analog Using Transglutaminase

In some embodiments, the pulse protein isolates are incorporated into a scrambled egg analog in which the pulse protein isolate (e.g., mung bean protein isolate) has been contacted with transglutaminase (or other cross-linking enzyme) to provide advantageous textural, functional and organoleptic properties. Food processing methods employing transglutaminases are known in the art.

In some embodiments, the transglutaminase is microencapsulated when utilized in the egg analogs provided herein. Microencapsulation of transglutaminase enzyme in such egg mimetic emulsions maintains a stable emulsion by preventing contact of the protein substrate with the transglutaminase enzyme. A cross-linking reaction is initiated upon heating to melt the microencapsulating composition. In some embodiments, the transglutaminase is immobilized on inert porous beads or polymer sheets, and contacted with the egg mimetic emulsions.

In certain aspects of the invention, the method for producing an egg substitute composition comprises contacting a pulse protein isolate with an amount of transglutaminase, preferably between 0.0001% to 0.1%. In some embodiments, the method provides an amount of transglutaminase between 0.001% and 0.05%. In some embodiments, the method provides an amount of transglutaminase between 0.001% and 0.0125%.

In various embodiments, the scrambled egg analog comprises a pulse protein isolate described herein, along with one or more of the following components: water, disodium phosphate and oil. In some embodiments, the scrambled egg analog further comprises NaCl. In some embodiments, the scrambled egg analog has been contacted with transglutaminase. In a particular embodiment, the scrambled egg analog comprises: Protein Solids: 11.3 g, Water: 81.79 g, Disodium phosphate: 0.4 g, Oil: 6.2 g, NaCl: 0.31 g (based on total weight of 100 g) wherein the protein solids are contacted with between 0.001% and 0.0125% of transglutaminase.

In some embodiments, the composition lacks lipoxygenase.

Vegan Patty

Pulse protein isolates (e.g., mung bean protein isolates) can be used as the sole gelling agent in a formulated vegan patty. In some embodiments, a hydrocolloid system comprised of iota-carrageenan and gum arabic enhances native gelling properties of the pulse protein isolate in a formulated patty. In other embodiments, a hydrocolloid system comprised of high-acyl and low-acyl gellan in a 1.5:1 ratio enhances native gelling properties of the pulse protein isolate in a formulated patty. In further embodiments, a hydrocolloid system comprised of konjac and xanthan gum enhances native gelling properties of the pulse protein isolate in a formulated patty.

Egg-Free Emulsion

In another embodiment, pulse protein isolates (e.g., mung bean protein isolates) are included in an edible egg-free emulsion. In some embodiments, the emulsion comprises one or more additional components selected from water, oil, fat, hydrocolloid, and starch. In some embodiments, at least or about 60-85% of the edible egg-free emulsion is water. In some embodiments, at least or about 10-20% of the edible egg-free emulsion is the pulse protein isolate. In some embodiments, at least or about 5-15% of the edible egg-free emulsion is oil or fat. In some embodiments, at least or about 0.01-6% of the edible egg-free emulsion is the hydrocolloid fraction or starch. In some embodiments, the hydrocolloid fraction comprises high-acyl gellan gum, low-acyl gellan gum, iota-carrageenan, gum arabic, konjac, locust bean gum, guar gum, xanthan gum, or a combination of one or more gums thereof. In some embodiments, the emulsion further comprises one or more of: a flavoring, a coloring agent, an antimicrobial, a leavening agent, and salt. In some embodiments, the emulsion further comprises phosphate.

In an embodiment, the edible egg-free emulsion has a pH of about 5.6 to 6.8. In some cases, the edible egg-free emulsion comprises water, a pulse protein isolate as described herein, an enzyme that modifies a structure of the protein isolate, and oil or fat. In some embodiments, the enzyme comprises a transglutaminase or proteolytic enzyme. In some embodiments, at least or about 70-85% of the edible egg-free emulsion is water. In some embodiments, at least or about 7-15% of the edible egg-free emulsion is the pulse protein isolate. In some embodiments, at least or about 0.0005-0.0025% (5-25 parts per million) of the edible egg-free emulsion is the enzyme that modifies the structure of the pulse protein isolate. In some embodiments, at least or about 5-15% of the edible egg-free emulsion is oil or fat.

Baked Cake Mixes and Batters

In another embodiment, pulse protein isolates (e.g., mung bean protein isolates) are included in one or more egg-free cake mixes, suitable for preparing one or more egg-free cake batters, from which one or more egg-free cakes can be made. In some embodiments, the egg-free cake mix comprises grain flour, for example, wheat flour or other grain flour, sugar, and a pulse protein isolate. In some embodiments, the egg-free cake mix further comprises one or more additional components selected from: cream of tartar, disodium phosphate, baking soda, and a pH stabilizing agent. In some embodiments, the flour comprises cake flour.

In another embodiment, pulse protein isolates (e.g., mung bean protein isolates) are included in an egg-free cake batter comprising an egg-free cake mix described above, and water. In some embodiments, the egg-free cake batter is an egg-free pound cake batter, an egg-free angel food cake batter, or an egg-free yellow cake batter. In some embodiments, the egg-free cake batter has a specific gravity of 0.95-0.99.

In an embodiment, an egg-free pound cake mix comprises wheat flour, sugar, and a pulse protein isolate. In some embodiments, the flour comprises cake flour. In some embodiments, the egg-free pound cake mix further comprises oil or fat. In some embodiments, the oil or fat comprises butter or shortening. In some embodiments, at least or about 25-31% of the egg-free pound cake batter is flour. In some embodiments, at least or about 25-31% of the egg-free pound cake batter is oil or fat. In some embodiments, at least or about 25-31% of the egg-free pound cake batter is sugar. In some embodiments, at least or about 6-12% of the egg-free pound cake batter is the pulse protein isolate. In some embodiments, the batter further comprises disodium phosphate or baking soda.

In an embodiment, an egg-free pound cake batter comprises an egg-free pound cake mix described above, and further comprises water. In some embodiments, the egg-free pound cake batter comprises about four parts of the egg-free pound cake mix; and about one part water. In some embodiments, at least or about 20-25% of the egg-free pound cake batter is wheat flour. In some embodiments, at least or about 20-25% of the egg-free pound cake batter is oil or fat. In some embodiments, at least or about 20-25% of the egg-free pound cake batter is sugar. In some embodiments, at least or about 5-8% of the egg-free pound cake batter is the pulse protein isolate. In some embodiments, at least or about 18-20% of the egg-free pound cake batter is water.

In an embodiment, an egg-free angel food cake mix comprises wheat flour, sugar, and a pulse protein isolate. In some embodiments, at least or about 8-16% of the egg-free angel food cake mix is wheat flour. In some embodiments, at least or about 29-42% of the egg-free angel food cake mix is sugar. In some embodiments, at least or about 7-10% of the egg-free angel food cake mix is the pulse protein isolate. In some embodiments, the egg-free angel food cake mix further comprises cream of tartar, disodium phosphate, baking soda, or a pH stabilizing agent. In some embodiments, the wheat flour comprises cake flour. Also provided herein is an egg-free angel food cake batter comprising an egg-free angel food cake mix described above, and water.

In an embodiment, an egg-free yellow cake mix comprises wheat flour, sugar, and a pulse protein isolate. In some embodiments, at least or about 20-33% of the egg-free yellow cake mix is wheat flour. In some embodiments, at least or about 19-39% of the egg-free yellow cake mix is sugar. In some embodiments, at least or about 4-7% of the egg-free yellow cake mix is the pulse protein isolate. In some embodiments, the egg-free yellow cake mix further comprises one or more of baking powder, salt, dry milk, and shortening. Also provided herein is an egg-free yellow cake batter comprising an egg-free yellow cake mix described above, and water.

Sensory quality parameters of cakes made with the pulse protein isolates are characterized as fluffy, soft, airy texture. The peak height is measured to be 90-110% of pound cake containing eggs. The specific gravity of cake batter with the purified pulse protein isolate is 0.95-0.99, similar to that of cake batter with whole eggs of 0.95-0.96.

Cream Cheese Analog

In another embodiment, pulse protein isolates (e.g., mung bean protein isolates) are included in an egg-free cream cheese. In some embodiments, the egg-free cream cheese comprises one or more additional components selected from water, oil or fat, and hydrocolloid. In some embodiments, at least or about 75-85% of the egg-free cream cheese is water. In some embodiments, at least or about 10-15% of the egg-free cream cheese is the pulse protein isolate. In some embodiments, at least or about 5-10% of the egg-free cream cheese is oil or fat. In some embodiments, at least or about 0.1-3% of the egg-free cream cheese is hydrocolloid. In some embodiments, the hydrocolloid comprises xanthan gum or a low-methoxy pectin and calcium chloride system. In some embodiments, the egg-free cream cheese further comprises a flavoring or salt. In some embodiments, one or more characteristics of the egg-free cream cheese is similar or equivalent to one or more corresponding characteristics of a cream cheese containing eggs. In some embodiments, the characteristic is a taste, a viscosity, a creaminess, a consistency, a smell, a spreadability, a color, a thermal stability, or a melting property. In some embodiments, the characteristic comprises a functional property or an organoleptic property. In some embodiments, the functional property comprises: emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, the organoleptic property comprises a flavor or an odor.

Egg-Free Pasta Dough

In another embodiment, pulse protein isolates (e.g., mung bean protein isolates) are included in an egg-free pasta dough. In some embodiments, the egg-free pasta dough comprises one or more additional components selected from grain flour, oil or fat, and water. In some embodiments, the flour comprises semolina flour. In some embodiments, the oil or fat comprises extra virgin oil. In some embodiments, the egg-free pasta dough further comprises salt. Also provided herein is an egg-free pasta made from an egg-free pasta dough described above. In some embodiments, the egg-free pasta is fresh. In some embodiments, the egg-free pasta is dried. In some embodiments, one or more characteristics of the egg-free pasta is similar or equivalent to one or more corresponding characteristics of a pasta containing eggs. In some embodiments, the one or more characteristics comprise chewiness, density, taste, cooking time, shelf life, cohesiveness, or stickiness. In some embodiments, the one or more characteristics comprise a functional property or an organoleptic property. In some embodiments, the functional property comprises: emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, the organoleptic property comprises a flavor or an odor.

Plant-Based Milk

In another embodiment, pulse protein isolates (e.g., mung bean protein isolates) are included in a plant-based milk. In some embodiments, the plant-based milk comprises one or more additional components selected from water, oil or fat, and sugar. In some embodiments, at least or about 5% of the plant-based milk is the pulse protein isolate. In some embodiments, at least or about 70% of the plant-based milk is water. In some embodiments, at least or about 2% of the plant-based milk is oil or fat. In some embodiments, the plant-based milk further comprises one or more of: disodium phosphate, soy lecithin, and trace minerals. In particular, embodiments, the plant-based milk is lactose-free. In other particular embodiments, the plant-based milk does not comprise gums or stabilizers.

Egg-Free Custard

In another embodiment, pulse protein isolates (e.g., mung bean protein isolates) are included in an egg-free custard. In some embodiments, the egg-free custard comprises one or more additional components selected from cream and sugar. In some embodiments, at least or about 5% of the egg-free custard is the pulse protein isolate. In some embodiments, at least or about 81% of the egg-free custard is cream. In some embodiments, at least or about 13% of the egg-free custard is sugar. In some embodiments, the egg-free custard further comprises one or more of: iota-carrageenan, kappa-carrageenan, vanilla, and salt. In some embodiments, the cream is heavy cream.

Egg-Free Ice Cream

In another embodiment, pulse protein isolates (e.g., mung bean protein isolates) are included in an egg-free ice cream. In some embodiments, the egg-free ice cream is a soft-serve ice cream or a regular ice cream. In some embodiments, the egg-free ice cream comprises one or more additional components selected from cream, milk, and sugar. In some embodiments, at least or about 5% of the egg-free ice cream is the protein isolate. In some embodiments, at least or about 41% of the egg-free ice cream is cream. In some embodiments, at least or about 40% of the egg-free ice cream is milk. In some embodiments, at least or about 13% of the egg-free ice cream is sugar. In some embodiments, the egg-free ice cream further comprises one or more of iota carrageenan, kappa carrageenan, vanilla, and salt. In some embodiments, the cream is heavy cream. In some embodiments, the milk is whole milk. In particular embodiments, the egg-free ice cream is lactose-free. In some embodiments, the egg-free ice cream does not comprise gums or stabilizers. In some embodiments, the egg-free ice provides a traditional mouthfeel and texture of an egg-based ice cream but melts at a slower rate relative to an egg-based ice cream.

Fat Reduction Shortening System (FRSS)

In another embodiment, pulse protein isolates (e.g., mung bean protein isolates) are included in a fat reduction shortening system. In some embodiments, the FRSS comprises one or more additional components selected from water, oil or fat. In some embodiments, the FRSS further comprises sodium citrate. In further some embodiments, the FRSS further comprises citrus fiber. In some embodiments, at least or about 5% of the FRSS is the pulse protein isolate. In preferred embodiments, the pulse protein-based FRSS enables a reduction in fat content in a food application (e.g., a baking application) utilizing the FRSS, when compared to the same food application utilizing an animal and/or dairy based shortening. In some embodiments, the reduction in fat is at least 10%, 20%, 30% or 40% when compared to the same food application utilizing an animal and/or dairy based shortening.

Meat Analogues

In another embodiment, pulse protein isolates (e.g., mung bean protein isolates) are included in a meat analogue. In some embodiments, the meat analogue comprises one or more additional components selected from water, oil, disodium phosphate, transglutaminase, starch and salt. In some embodiments, at least or about 10% of the meat analogue is the pulse protein isolate. In some embodiments, preparation of the meat analogue comprises mixing the components of the meat analogue into an emulsion and pouring the emulsion into a casing that can be tied into a chubb. In some embodiments, chubs containing the meat analogue are incubated in a water bath at 50° C. for 2 hours. In further embodiments, the incubated chubbs are pressure-cooked. In some embodiments, the pressure-cooking occurs at 15 psi at about 121° C. for 30 minutes.

Food Applications: Co-Ingredients

Various gums, phosphates, starches, preservatives, and other ingredients may be included in the food compositions comprising the pulse protein isolates.

Various gums useful for formulating one or more pulse protein based food products described herein include, e.g., konjac, gum acacia, Versawhip, Guar+Xanthan, Q-extract, CMC 6000 (Carboxymethylcellulose), Citri-Fi 200 (citrus fiber), Apple fiber, Fenugreek fiber.

Various phosphates useful for formulating one or more pulse protein based food products described herein include disodium phosphate (DSP), sodium hexamethaphosphate (SHMP), and tetrasodium pyrophosphate (TSPP).

Starch may be included as a food ingredient in the pulse protein food products described herein. Starch has been shown to have useful emulsifying properties; starch and starch granules are known to stabilize emulsions. Starches are produced from plant compositions, such as, for example, arrowroot starch, cornstarch, tapioca starch, mung bean starch, potato starch, sweet potato starch, rice starch, sago starch, wheat starch.

In certain embodiments, the food compositions comprise an effective amount of an added preservative in combination with the pulse protein isolate. The preservative may include ascorbic acid, citric acid, sodium benzoate, calcium propionate, sodium erythorbate, sodium nitrite, calcium sorbate, potassium sorbate, BHA, BHT, EDTA, tocopherols (Vitamin E) or antioxidants.

Storage and Shelf Life of Food Compositions

In some embodiments, the food compositions comprising the pulse protein isolates may be stable in storage at room temperature for up to 1, 2, 3, 4, 5, 6, 7, 8, 9, or 10 weeks. In some embodiments, the food compositions comprising the pulse protein isolates may be stable for storage at room temperature for months, e.g., greater than 1, 2, 3, 4, 5, 6, 7, 8, 9, 10, 11, 12, or 13 months. In some embodiments, the food compositions comprising the pulse protein isolates may be stable for refrigerated or freezer storage for months, e.g., greater than 1, 2, 3, 4, 5, 6, 7, 8, 9, 10, 11, 12, or 13 months. In some embodiments, the food compositions comprising the pulse protein isolates may be stable for refrigerated or freezer storage for years, e.g., greater than 1, 2, 3, 4, 5, 6, 7, 8, 9, 10, 11, 12, or 13 years.

In some embodiments, storage as a dry material can increase the shelf life of the pulse protein isolate or a food composition comprising the pulse protein isolate. In some embodiments, the pulse protein isolate or a food composition comprising the pulse protein isolate is stored as a dry material for later reconstitution with a liquid, e.g., water. In some embodiments, the pulse protein isolate or the food composition is in powdered form, which may be less expensive to ship, lowers risk for spoilage and increases shelf-life (due to greatly reduced water content and water activity).

In various embodiments, a food composition (e.g., an egg-free liquid egg analog product) comprising the pulse protein isolate has a viscosity of less than 500 cP after storage for thirty days at 4° C. In some cases, the composition has a viscosity of less than 500 cP after storage for sixty days at 4° C. In various embodiments, a food composition (e.g., an egg-free liquid egg analog product) comprising the pulse protein isolate has a viscosity of less than 450 cP after storage for thirty days at 4° C. In some cases, the composition has a viscosity of less than 450 cP after storage for sixty days at 4° C.

Although any methods and materials similar or equivalent to those described herein can be used in the practice or testing of the present invention, the preferred methods and materials are now described. All patents, applications and non-patent publications mentioned in this specification are incorporated herein by reference in their entireties.

### EXAMPLES

The following examples are put forth so as to provide those of ordinary skill in the art with a complete disclosure and description of how to make and use the methods and compositions of the invention, and are not intended to limit the scope of what the inventors regard as their invention. Efforts have been made to ensure accuracy with respect to numbers used (e.g., amounts, temperature, etc.) but some experimental errors and deviations should be accounted for. Unless indicated otherwise, parts are parts by weight, molecular weight is average molecular weight, temperature is in degrees Centigrade, and pressure is at or near atmospheric.

### Example 1: Heat Treatment of a Pulse and Manufacture of Heat Treated Pulses

Mung beans were purchased from a commercial source and heat treated. Mung beans were heat treated in a RevTech machine (Revtech, PA Champgrand, 50 allee des abricotiers, 26270 Loriol Sur Drome, France). The mung beans were continuously moved through the stainless-steel vertical spiral tubes assisted with vibrational movement of the unit. The vertical angle and oscillation frequency of the vertical vibratory tubes determines the speed of the mung beans traveling through the tubes. The beans are fed from the bottom and travel upwards through the tubes and were discharged from the top outlet into a fluidized bed cooler (cooling zone) where the beans are cooled down.

The spiral tubes can be divided into various heating zones for differential heat treatment as the mung beans travels upward through the tubes. The residence time in each zone can be controlled based on the speed and number of tubes selected for each heating zone.

The heat treatment was divided into two heating zones (zone 1 and 2) in the vertical vibratory tubes and one cooling zone (zone 3) in the fluidized bed cooler. The zone 1 temperature was kept between 100° C. to 150° C. and steam was added at 5% by weight basis of the beans being fend into the dryer per hour. The steam was generated through a standard boiler installation and injected through connecting tubes directly into zone 1 of the RevTech machine. The zone 2 temperature was kept between 140° C. to 225° C. The residence time through zone 1 was 3 minutes and through zone 2 was 3 minutes, for total heat treatment of 6 min. After the beans passed through both heating zones, the beans were conveyed into the fluidized bed dryer (cooling zone) and cooled down to 30° C.-50° C.

Heat treatment of pulses was also performed in batch mode or a continuous mode in a fluidized bed dryer. In this heat treatment regime, the beans were exposed to heat and steam treatment in the fluidized bed dryer. In batch mode operation, the mung beans were fed into the fluidized bed dryer at a rate of between 1 to 20 kg/hr on a metal screen bed with or without shaking motion. The mung beans were placed on a metal screen inside an enclosed stainless steel cylindrical chamber and hot air at 250° C. (heating zone) was blown in an upward direction through the bottom of the screen at a velocity sufficient to fluidize the mung beans (into air) to facilitate contact between the hot air and mung beans. The mung beans were exposed to hot air for anywhere between 20 second to 30 min. The hot air can also be blown from the top to bottom direction, relative to the metal screen bed, in other configurations of fluidized bed dryers. After the heat treatment was completed, the room temperature or cold air was blown onto the beans to cool down the mung beans to 30° C.-50° C. (cooling zone). After the beans were cooled to a desired temperature, the enclosed stainless steel chamber was opened and the beans were milled to prepare the heat-treated pulse.

### Example 2: Pilot Scale Wet Milling Heat Treated Pulse

The heat-treated pulse of Example 1 were steeped and milled.

20 kg dehulled yellow mung bean was steeped with 60 kg of water, 300 g salt (NaCl) and 50 mL of antifoam (Aqua Hawk® S105, Hawkins Inc, Minneapolis, MN, USA). 60 kg of water was heated to between 50-52° C. with Mokon portable heater (Mokon, 2150 Elmwood Avenue, Buffalo, NY 14207) and added into a Breddo liquefier (Corbion Inc). 20 kg of dehulled yellow mung beans was then added to the Breddo liquefier (Corbion Inc), mixed and steeped for 30 min. After 30 min, the steeped bean and water were pumped through a Boston Shear Mill (Admix, Inc., 144 Harvey Road, Londonderry, NH 03053) for milling to achieve the desired particle size distribution. The particle size distribution was determined using Mastersizer 3000 (Malvern Panalytical Ltd, Malvern, United Kingdom). 40 kg of water added to the slurry, mixed for 2.5 min and the pH was adjusted to 7.0 using 1 M NaOH solution. The wet-milled pulse flour slurry was collected in a kettle for protein extraction processing.

Dry milled mung bean pulse was added to water in 1:3 ratio with one part pulse flour and three parts water. The slurry was mixed well to have the pulse flour completely suspended in the water. This slurry's particle size distribution was determined using Mastersizer 3000 (Malvern Panalytical Ltd, Malvern, United Kingdom) and compared with the wet milled slurry.

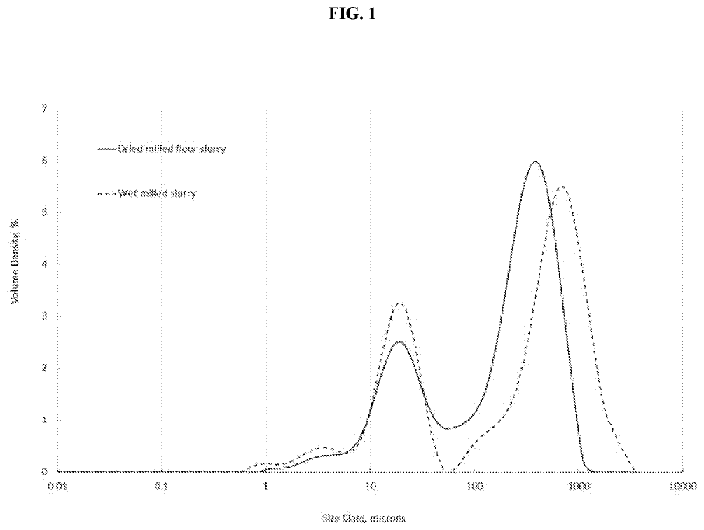

FIG. 1 shows the particle size distribution of the wet-milled and dry milled mung bean pulses. As disclosed in FIG. 1, the average particle sizes of the two smaller particle fractions were about the same for both the wet milled pulse and the dry milled pulse, 0.5 μm and 8 μm and 10 μm and 100 μm, respectively. However, for the large particle size fraction, the average particle sizes of the wet milled and dried milled pulses differed. The average particle size of the large particle size fraction of the dry milled pulse was between 100 μm or 1000 μm or between 400 μm or 1500 μm.

The trimodal particle size distribution of the dry milled particles have an average particle size of about 1 μm, about 20 μm and about 650 μm. The trimodal particle size distribution of the wet milled pulse have average particle sizes of about 1 μm, about 20 μm and about 650 μm.

### Example 3: Protein Isolation

The wet-milled pulse of Example 2 was centrifuged to perform a starch solid separation using a decanter (SG2-100, Alfalaval Inc). The major portion of the starch solids and unextracted material (decanter heavy phase) of Example 2 was separated from the liquid suspension (decanter light phase). The resuspension stream (light phase) was further clarified using a disc stack centrifuge (Clara 80, Alfalaval Inc.) into a high solids slurry (disc stack heavy phase) and a clarified resuspension (disc stack light phase). The disc stack heavy phase typically consists of fat, ash, starch and the protein carried over with the liquid portion of the slurry. The disc stack light phase was then transferred to the liquefier tank. The pH was adjusted to 5.2 with 20% w/w citric acid. The slurry was mixed and run through the decanter (SG2-100, Alfalaval Inc.) in recirc mode until the spin down on the decanter light phase was negligible. Then the decanter was shut down and the protein pellet collected on the decanter heavy phase side. The pellet was resuspended with 4.0× deionized water to get the concentration in the range to minimize spray drier losses. The resuspended protein solution was adjusted to a pH of 6 using 1M NaOH. This material was then heat treated using a microthermics UHT unit with the pasteurization condition set at 72.5° C. and 30 sec hold time.

### Example 4: Volatile Compound Analysis of Wet-Milled Mung Bean Pulse

The volatile small molecule compounds present in the isolated mung bean protein of Example 3 were determined by head space gas analysis by GC/MS.

A GC-MS system—Thermo 1310 gas chromatograph (Thermo Fisher Scientific, Waltham, MA) with a Thermo TSQ8000 Evo mass spectrometer (Thermo Fisher Scientific, Waltham, MA) was used for analysis. For extraction of volatiles, mung beanprotein isolate (2 g) was placed in 20 mL GC glass headspace extraction vial (Size 22×75 mm, Restek, Bellefonte, PA). A polytetrafluoro ethylene septa and metal screw cap (Thread size 20 mm, Restek, Bellefonte, PA) was used to cap each vial. A Thermo Scientific TriPlus RSH Autosampler was used to load vials in the agitator. After a 15-minute incubation period at 80° C., VOCs were extracted from the sample by dynamic headspace (DHS) with 25 extraction strokes. Gas (helium) flow rate used was 1 mL/min and a target column temperature of 220° C. was applied. The DHS technique utilized a PAL3 ITEX Trap Tenax TA 80/100 mesh (23 needle gauge size, LEAP PAL Parts and Consumables, Raleigh, NC) for extraction. After extraction was completed, volatile compounds were desorbed onto a HP-5MS capillary column (30 m×0.25 mm×0.25 μm; Agilent J&W GC Columns, Santa Clara, CA)—that resulted in the separation of the compounds. A mass spectrometer was used to detect ions within a range of 40-400 m/z with an electro mode at 70 eV.

All volatile compound peaks were analyzed using Chromeleon 7.2 software (Thermo Fisher Scientific, Waltham, MA). The VOCs selected for analysis are compounds likely to be contributors to off-flavors in the isolate. The VOCs analyzed were identified by use of high purity (>98%) reference standards, which were run on the same GCMS method and used to confirm VOC identification by corroborating retention time and mass spectra with those of compounds in the protein isolate samples.

Peak area quantitation of each individual volatile organic compound component was quantitated by peak area integration followed by normalizing for the moisture content of the isolate.

Table 1 shows a list of volatile organic compounds present in control dry-milled mung beans and mung beans that were wet-milled under several conditions. The table shows that a number volatile organic compounds decrease as a result of wet milling. In addition, Table 1 shows that a few volatile organic compounds remained the same for both dry-milled and wet-milled mung bean pulses.

TABLE 1

| | | | | | JA585 |
|---|---|---|---|---|---|
| | | | JA579 | JA569 | (Boston |
| | | | (Boston | (−Boston | shear |
| | | | shear | shear | mill |
| | | | mill | mill wet | wet mill |
| | | | wet | grind | grind |
| | | | grind | coarse | with |
| | | | coarse | d-WET | medium |
| | | JA56- | grind- | MILL) | heads- |
| | | DRY | normal- | normal- | normal- |
| Volatile | | MILL) | ized | ized | ized |
| Organic | | VOC | VOC | VOC | VOC |
| Com- | Odor | peak | peak | peak | peak |
| pounds | descriptors | area | area | area | area |
| Hexanal | grassy, green, | 1.24E+08 | 3.89E+07 | 4.42E+07 | 2.26E+07 |
| | sharp | | | | |
| 2- | green apple | 3.04E+06 | 7.20E+05 | 6.15E+05 | 5.61E+05 |
| Hexenal | like, citrus, | | | | |
| | green, fruity | | | | |
| 1- | sharp, almond, | 1.68E+06 | 1.31E+06 | 1.29E+06 | 1.04E+06 |
| Hexanol | solvent, flower, | | | | |
| | green, resin | | | | |
| 2- | typical blue | 7.69E+06 | 6.41E+06 | 4.33E+06 | 1.91E+06 |
| heptanone | cheese | | | | |
| | character along | | | | |
| | with fruity, | | | | |
| | waxy and green | | | | |
| | notes and also | | | | |
| | emits banana- | | | | |
| | like fruity odor | | | | |
| 2- | musty, oily, | 6.27E+06 | 5.03E+06 | 4.47E+06 | 2.72E+06 |
| heptanal | sweet, solvent | | | | |
| 2-pentyl | sweet, | 9.86E+06 | 7.54E+06 | 4.59E+06 | 2.55E+06 |
| furan | nauseating, | | | | |
| | musty, sharp | | | | |
| Nonanal | aldehydic, | 1.15E+08 | 6.20E+07 | 5.70E+07 | 2.70E+07 |
| | oily, soapy | | | | |
| Pentanal | aldehydic, | 6.67E+06 | 2.35E+06 | 2.99E+06 | 2.23E+06 |
| | oily, sharp, | | | | |
| | malt, pungent, | | | | |
| | almond | | | | |
| Dimethyl | sulfurous odor | 5.39E+06 | 8.74E+06 | 5.34E+06 | 3.53E+06 |
| Disulfide | and flavor | | | | |
| Octanal | fruit-like | 4.02E+06 | 2.36E+06 | 2.68E+06 | 1.39E+06 |

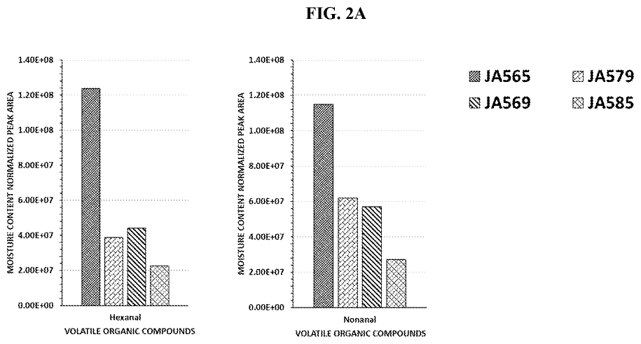

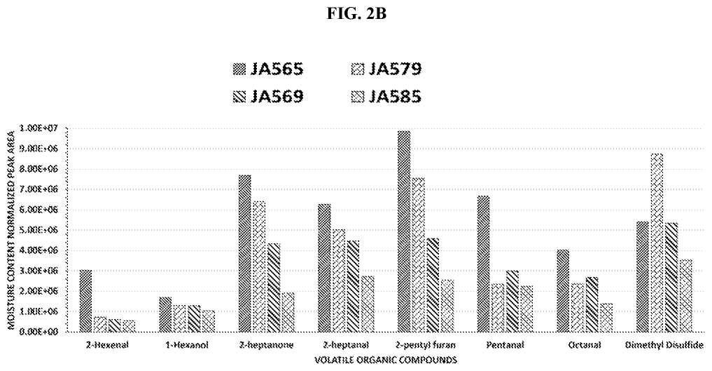

FIGS. 2A-2B show a comparison of the relative abundance of VOCs in isolates produced from the same lot of mung beans with different milling conditions. A control isolate made with dry-milled pulse (JA565) is compared to isolated made from wet-milled pulse (JA569, JA579, and JA585).

### Example 5: Wet Milling Heat Treated Pulse

100 g of dehulled heat-treated mung beans were wet milled and analyzed for protein recovery.

100 g of dehulled heat-treated mung beans were placed in a 250 mL Pyrex glass bottle and 200 g of deionized (DI) water was added. The temperature of a water bath was maintained at 52° C. If Nisin and SO₂ (antimicrobials) were used in the experiment, 1% w/w Nisin (Niprosin, Pro Food International, Naperville, IL 60563) and 1000 ppm SO₂ (Sodium Metabisulfite, ThermoFisher Scientific, NJ 07410) were used. 200 g DI water, mung beans added Nisin and SO₂).

The pH of the mung bean in water was adjusted to pH to 4.5 or 7.0 with 20% citric acid or 1M NaOH. The bottle containing mung beans and DI water was placed in a water bath maintained at a temperature of 52° C., ensuring that the water level inside the bottle is below the water level in water bath. After steeping for 16 hours, the steeped bean were separated from the steep water and both the steeped means and the steep water were collected. After separating the steep water and the bean, the beans were placed back into the bottle. The collected steep water was retained for moisture and proximate measurement.

A second aliquot of 200 g of DI water was added to the bottle containing the steeped beans, mixed well and transferred to a Thermomix (Vorwerk, Wuppertal, Germany) bowl. The Thermomix bowl was placed into the base unit and the beans were milled a setting of 6 for one minute and paused the milling for one minute so as not to overheat the beans. After the one minute pause, the beans were milled for an additional minute. After the milling was done, the wet-milled was transferred to a wide mouth container. The Thermomix bowl and top cover were washed with 200 g of DI water and the milled slurry was collected. This wet mill step could also be completed with the steep water collected at the end of the steeping step.

1. An isolated wet-milled pulse plant protein composition, the isolated plant protein composition comprising volatile small molecule compounds, wherein the amount of volatile small molecule compounds present in the isolated plant protein composition is decreased as compared to the amount of volatile small molecule compounds present in an isolated dry-milled plant protein composition.

2.-10. (canceled)

11. The isolated plant protein composition of claim 1, wherein the pulse selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soy beans, and mucuna beans.

12. The isolated plant protein composition of claim 1, wherein the pulse is dehulled.

13. The isolated plant protein composition of claim 1, wherein the pulse is of the genus Vigna.

14. The isolated plant protein composition of claim 13, wherein the pulse is Vigna angularis or Vigna radiata.

15. The isolated plant protein composition of claim 14, wherein the pulse is Vigna radiata.

16. The isolated plant protein composition of claim 1, wherein the small molecule is selected from the group consisting of hexanal; 2-hexenal; 1-hexanol; 2-heptanone; 2-heptanal; 2-pentyl furan; nonanal; pentanal; octanal; dimethyl disulfide, and combinations thereof.

17.-19. (canceled)

20. A method of manufacturing an isolated plant protein composition, the method comprising the steps of:
incubating a pulse in an aqueous solvent to prepare a hydrated pulse;
milling the hydrated pulse to prepare wet-milled pulse; and
isolating the plant protein composition from the wet-milled pulse;
the isolated plant protein composition comprising volatile small molecule compounds, wherein the amount of volatile small molecule compounds present in the isolated dry-milled plant protein composition is decreased as compared to the amount of volatile small molecule compounds present in an isolated dry-milled plant protein composition.

21. (canceled)

22. The method of claim 20, wherein the pulse is wet-milled in an aqueous solvent at a pH of from about 1 to about 10.

23.-30. (canceled)

31. The method of claim 20, wherein the aqueous solvent is at a temperature of between 2° C. and 75° C.

32. (canceled)

33. The method of claim 20, wherein the pulse is milled for a period of between 5 seconds and 240 minutes.

34. The method of claim 20, wherein the aqueous solvent comprises a salt.

35. The method of claim 34, wherein the salt is selected from the group consisting of NaCl, NaHCO₃, Na₂CO₃, Na₂SO₄, NaH₂PO₄, Na₂HPO₄, Na₃PO₄. Na₂SO₄, KCl, KHCO₃, K₂CO₃, Na₂SO₄, KH₂PO₄, K₂HPO₄, K₃PO₄. K₂SO₄, sodium citrate, sodium acetate, potassium citrate, and potassium acetate.

36.-39. (canceled)

40. The method of claim 20, wherein the pulse selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soy beans, and mucuna beans.

41. The method of claim 40, wherein the pulse is of the genus Vigna.

42. The method of claim 41, wherein the pulse is Vigna angularis or Vigna radiata.

43. The method of claim 42, wherein the pulse is Vigna radiata.

44. The method of claim 20, wherein the small molecule is selected from the group consisting of hexanal; 2-hexanal; 1-hexanol; 2-heptanone; 2-heptanal; 2-pentyl furan; nonanal; pentanal; 1-pentanol; 3,5-octadien-2-one; octanal; and combinations thereof.

45. (canceled)

46. A method of preparing a wet-milled pulse, the method compromising the steps of:
incubating a pulse in an aqueous solvent to prepare a hydrated pulse;
milling the hydrated pulse to prepare the wet-milled pulse; and
removing the aqueous solvent from the wet-milled pulse to prepare the wet-milled pulse;
the wet-milled pulse comprising volatile small molecule compounds, wherein the amount of volatile small molecule compounds present in the wet-milled pulse is decreased as compared to the amount of volatile small molecule compounds present in a dry-milled pulse.

47.-50. (canceled)

51. The method of claim 46, wherein the pulse is wet-milled in an aqueous solvent at a pH of from about 1 to about 10.

52. (canceled)

53. The method of claim 46, wherein the aqueous solvent is removed to prepare a dry wet-milled pulse.

54.-55. (canceled)

56. The method of claim 46, wherein the aqueous solvent is at a temperature of between 2° C. and 75° C.

57. (canceled)

58. The method of claim 46, wherein the pulse is milled for a period of between 5 seconds and 240 minutes.

59. The method of claim 46, wherein the aqueous solvent comprises a salt.

60. The method of claim 59, wherein the salt is selected from the group consisting of NaCl, NaHCO₃, Na₂CO₃, Na₂SO₄, NaH₂PO₄, Na₂HPO₄, Na₃PO₄. Na₂SO₄, KCl, KHCO₃, K₂CO₃, Na₂SO₄, KH₂PO₄, K₂HPO₄, K₃PO₄, K₂SO₄, sodium citrate, sodium acetate, potassium citrate, and potassium acetate.

61.-62. (canceled)

63. The method of claim 46, wherein the pulse selected from the group consisting of dry beans, lentils, mung beans, faba beans, dry peas, chickpeas, cowpeas, bambara beans, pigeon peas, lupins, vetches, adzuki, common beans, fenugreek, long beans, lima beans, runner beans, tepary beans, soy beans, and mucuna beans.

64. The method of claim 63, wherein the pulse is of the genus Vigna.

65. The method of claim 64, wherein the pulse is Vigna angularis or Vigna radiata.

66. The method of claim 41, wherein the pulse is Vigna radiata.

67. The method of claim 46, wherein the volatile small molecule is selected from the group consisting of hexanal; 2-hexanal; 1-hexanol; 2-heptanone; 2-heptanal; 2-pentyl furan; nonanal; pentanal; 1-pentanol; 3,5-octadien-2-one; octanal; and combinations thereof.

68. (canceled)

69. An egg substitute comprising the isolated plant protein composition of claim 1.
